(19) United States
(12) Patent Application Publication
(10) Pub. No.: US 2012/0167100 A1
(43) Pub. Date: Jun. 28, 2012

(54) MANUAL SUSPEND AND RESUME FOR NON-VOLATILE MEMORY

(76) Inventors: Yan Li, Milpitas, CA (US); Alon Marcu, Tel-Mond (IL); Cynthia Hsu, San Jose, CA (US); Grishma Shah, San Jose, CA (US); Cuong Trinh, Fremont, CA (US); Mehrdad Mofidi, Fremont, CA (US)

(21) Appl. No.: 12/978,001

(22) Filed: Dec. 23, 2010

(51) Int. Cl. G06F 9/46; G06F 3/00

(52) U.S. Cl. 718/102; 710/19; 710/5

(57) ABSTRACT

An external controller has greater control over control circuitry on a memory die in a non-volatile storage system. The external controller can issue a manual suspend command on a communication path which is constantly monitored by the control circuitry. In response, the control circuitry suspends a task immediately, with essentially no delay, or at a next acceptable point in the task. The external controller similarly has the ability to issue a manual resume command, which can be provided on the communication path when that path has a ready status. The control circuitry can also automatically suspend and resume a task. The external controller can cause a task to be suspended by issuing an illegal read command. The external controller can cause a suspended program task to be aborted by issuing a new program command.

### BACKGROUND

The present technology relates to non-volatile memory.

Semiconductor memory has become increasingly popular for use in various electronic devices. For example, non-volatile semiconductor memory is used in cellular telephones, digital cameras, personal digital assistants, mobile computing devices, non-mobile computing devices and other devices. Electrically Erasable Programmable Read Only Memory (EEPROM) and flash memory are among the most popular non-volatile semiconductor memories. With flash memory, also a type of EEPROM, the contents of the whole memory array, or of a portion of the memory, can be erased in one step, in contrast to the traditional, full-featured EEPROM.

Both the traditional EEPROM and the flash memory utilize a floating gate that is positioned above and insulated from a channel region in a semiconductor substrate. The floating gate is positioned between the source and drain regions. A control gate is provided over and insulated from the floating gate. The threshold voltage (Vth) of the transistor thus formed is controlled by the amount of charge that is retained on the floating gate. That is, the minimum amount of voltage that must be applied to the control gate before the transistor is turned on to permit conduction between its source and drain is controlled by the level of charge on the floating gate.

Some EEPROM and flash memory devices have a storage element or cell with a floating gate that is used to store two ranges of charges and, therefore, the storage element can be programmed/erased between two states, e.g., an erased state and a programmed state. Such a flash memory device is sometimes referred to as a binary flash memory device because each storage element can store one bit of data.

A multi-state (also called multi-level) flash memory device is implemented by identifying multiple distinct allowed/valid programmed threshold voltage ranges. Each distinct threshold voltage range corresponds to a predetermined value for the set of data bits encoded in the memory device. For example, each storage element can store two bits of data when the element can be placed in one of four discrete charge bands corresponding to four distinct threshold voltage ranges.

Typically, the storage elements are provided in one or more arrays on a memory die with associated control circuitry. The control circuitry in turn communicates with an external controller, which itself may communicate with a host electronic device. However, techniques are need with which allow the external controller to have greater control over the control circuitry.

### BRIEF DESCRIPTION OF THE DRAWINGS

In the drawings, like-numbered elements correspond to one another.

FIG. 1 provides an example of a non-volatile storage system in which an external controller communicates with control circuitry on one or more memory die.

FIG. 2 is a block diagram of a non-volatile memory system using single row/column decoders and read/write circuits.

FIG. 3 is a block diagram depicting one embodiment of the sense block 100 of FIG. 1B.

FIG. 4 is a block diagram of an array of NAND flash memory cells which can be used in the memory array 105 of FIG. 1B.

FIG. 5A depicts an example set of threshold voltage distributions.

FIG. 5B illustrates a first pass of a two-pass programming technique for two-bit, four-level storage elements.

FIG. 5C illustrates a second pass of the two-pass programming technique of FIG. 5B.

FIG. 5D illustrates a first pass of another two-pass programming technique for two-bit, four-level storage elements.

FIG. 5E illustrates a second pass of the two-pass programming technique of FIG. 5D.

FIG. 5F depicts a back-and-forth word line order for a two-pass program operation for a set of storage elements.

FIG. 5G depicts a back-and-forth word line order for a three-pass programming operation for a set of storage elements.

FIGS. 5H-K depict programming of lower, middle and upper pages for three-bit, eight-level storage elements.

FIG. 6A depicts an overview of a process in which an external controller communicates with control circuitry on a memory die.

FIG. 6B depicts details of an example embodiment of the process of FIG. 6A, where the external controller suspends a task at control circuitry.

FIG. 6C depicts examples of a record which identifies in-progress tasks as discussed at step 614 of FIG. 6B.

FIG. 7A depicts a series of program-verify iterations which are performed for a selected word line during a programming operation.

FIG. 7B depicts one of the program pulses of FIG. 7A showing a manual suspend command.

FIG. 7C depicts one of the sets of verify pulses of FIG. 7A showing a manual suspend command

FIG. 7D depicts a voltage waveform used in an erase operation.

FIG. 7E depicts one of the erase pulses of FIG. 7D showing a manual suspend command.

FIG. 7F depicts one of the erase verify pulses of FIG. 7D showing a manual suspend command.

FIG. 8A-8G depict example task sequences based on the process of FIG. 6A.

FIG. 9A depicts an example scenario based on the process of FIG. 6A, where the external controller provides a manual suspend command and a manual resume command to control circuitry.

FIG. 9B depicts an example scenario which can follow the scenario of FIG. 9A, where a program task completes so that no manual suspend is needed to allow a read task to execute.

FIG. 10 depicts an example scenario based on the process of FIG. 6A, where the external controller provides a manual suspend command to control circuitry to suspend a first program task to allow a read task to execute, and a second program task which causes the first program task to be aborted.

FIG. 11 depicts an example scenario based on the process of FIG. 6A, where the external controller provides a manual suspend command to control circuitry to suspend a program task, but the program task completes so that it is not suspended.

FIG. 12A depicts an example scenario based on the process of FIG. 6A, where the external controller provides a manual suspend command to control circuitry, and the control circuitry performs an automatic suspend and resume.

FIG. 12B depicts a configuration of data latches after the first data transfer of FIG. 12A.

FIG. 12C depicts a configuration of data latches after the second data transfer of FIG. 12A.

FIG. 12D depicts a configuration of data latches after the third data transfer of FIG. 12A.

FIG. 13 depicts an example scenario based on the process of FIG. 6A, where the external controller provides a manual suspend command to control circuitry to enter a low power mode, after which the external controller provides a manual resume command

FIG. 14 depicts an example scenario based on the process of FIG. 6A, where the external controller provides an illegal read command to control circuitry to cause the control circuitry to suspend a task, after which read data is output to the external controller from a cache of the control circuitry while concurrently a program task is performed.

FIG. 15 depicts an example scenario based on the process of FIG. 6A, where the external controller provides an illegal read command to control circuitry to cause the control circuitry to suspend a task, after which read data is output to the external controller.

FIG. 16 depicts an example scenario based on the process of FIG. 6A, where the external controller provides a legal read command to control circuitry to cause the control circuitry to suspend a first program task, after which the external controller issues a second program task to cause the first program task to be aborted.

FIG. 17 depicts an example scenario based on the process of FIG. 6A, where the external controller provides an illegal read command to control circuitry to cause the control circuitry to suspend a program task, but the program task completes so that it is not suspended.

### DETAILED DESCRIPTION

A method and non-volatile storage system are provided in which an external controller has greater control over control circuitry on a memory die.

In an embedded system application for non-volatile storage, an external controller is used to control on-chip control circuitry which in turn communicates with a storage element array. The external controller acts as an interface between a host/user and the control circuitry. The control circuitry can include a state machine which manages algorithms for a flash memory chip. The external controller can manage protocols, error correction coding (ECC) and decoding, wear leveling and other processes for one or more memory die.

The control circuitry can perform tasks such as program, read, erase, garbage collecting and entering a low power mode, in response to commands from the external controller. Garbage collecting is a form of automatic memory management in which memory space occupied by data that is no longer needed reclaimed. The control circuitry can automatically suspend and resume a task such as to service a higher-priority command received from the external controller. However, the external controller may experience unknown or unacceptable delays in waiting for the control circuitry to automatically suspend and resume a task. In one approach, the external controller has the ability to issue a manual suspend command on a communication path or channel which is constantly monitored by the control circuitry, and the control circuitry responds by suspending a currently-executing task as soon as possible. The control circuitry is configured to suspend a task either immediately, with essentially no delay, or at a next acceptable point in the task. The external controller similarly has the ability to issue a manual resume command, which can be provided on the communication path when the control circuitry has a ready status.

Example scenarios include manual suspend without manual resume, manual resume without manual suspend and combining a manual suspend and/or resume with an automatic suspend and/or resume. An automatic suspend is performed by the control circuitry in response to a command sequence, which is something other than a manual suspend command, from the external controller. An automatic suspend is performed by the control circuitry on its own, and not in response to a manual suspend command or other command. In some cases, a task is not suspended even when a manual suspend command is issued since, e.g., the task has completed.

In another embodiment, the external controller does not issue a manual suspend command, but can issue an illegal command which causes a task to be suspended. Further, the external controller can issue a command which causes a suspended task to be aborted, so that it cannot be resumed. Many variations are possible in which the external controller has an improved ability to control the control circuitry.

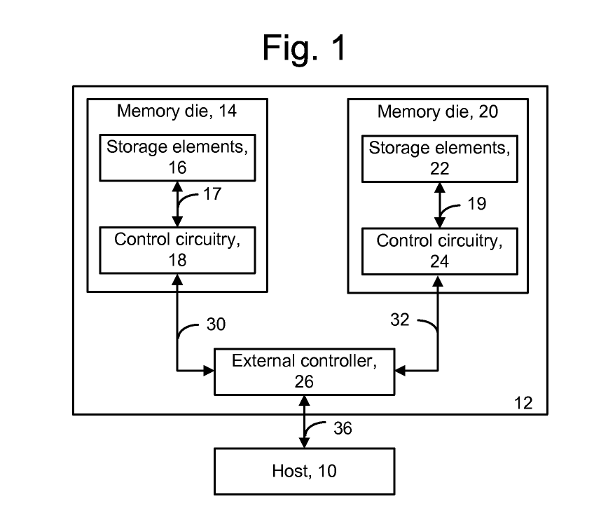

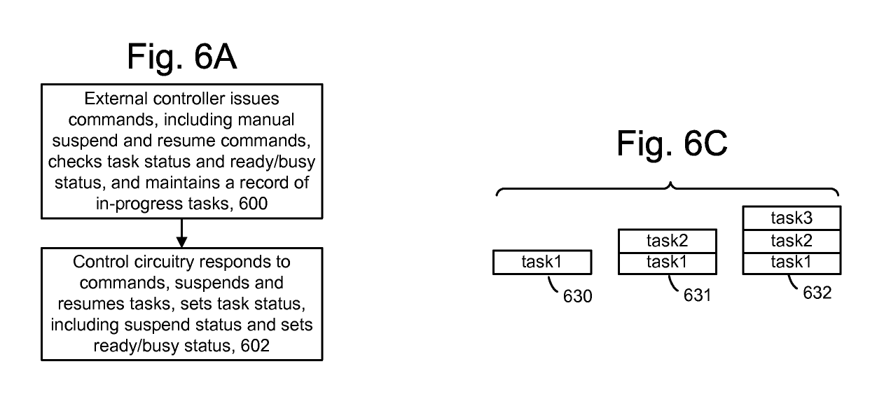

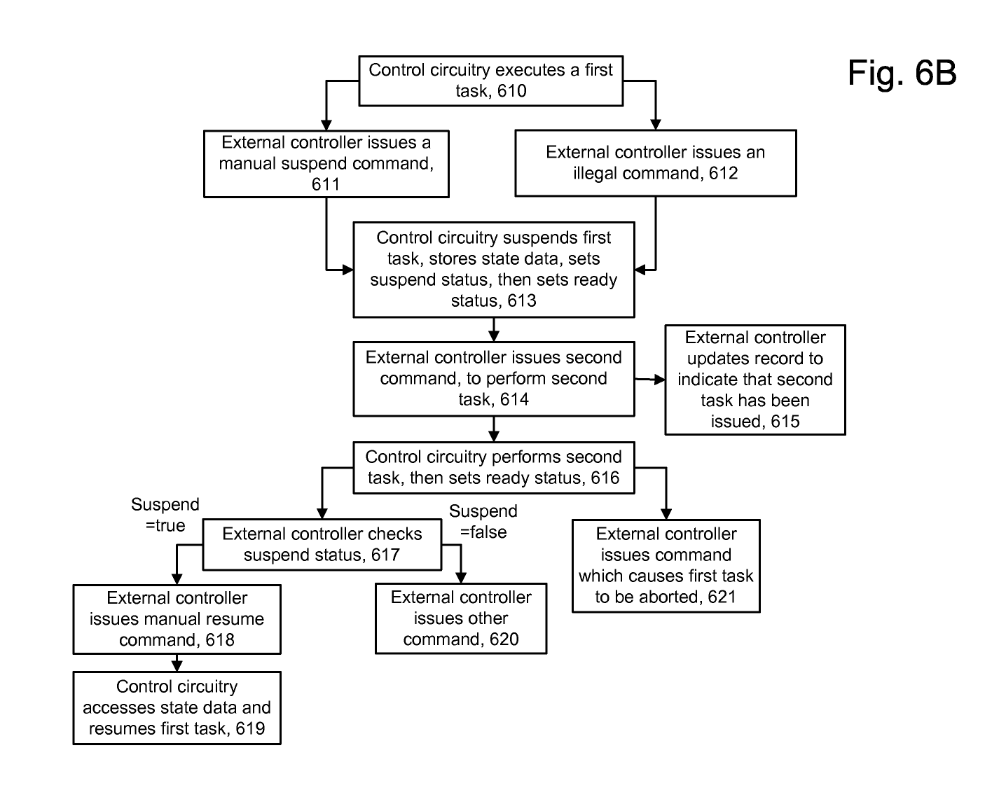

Generally, in the discussion below, FIGS. 1-5K provide information regarding the operation and construction of a non-volatile storage system, and FIGS. 6A-17 provide specific information regarding the interaction of the external controller and the control circuitry.

FIG. 1 provides an example of a non-volatile storage system in which an external controller communicates with control circuitry on one or more memory die. A host 10 communicates with an external controller 26 via one or more communication paths 36 such as one or more buses. The external controller, which can be a microcontroller, in turn can communicate with one or more memory die. Furthermore, multiple communication paths such as buses can be provided between the external controller and control circuitry on each die. For example, communication paths 30 and 32 are provided between the external controller 26 and the control circuitry 18 and 24, respectively. At least one communication path can be provided between the external controller and control circuitry.

The communication path can have a ready or busy status (identified by the signal ExternalBusyn discussed further below) which is set by the control circuitry to indicate whether it is ready or busy. In one possible option, the external controller can access a ready/busy pin to determine the ready/busy status, via an auxiliary channel. In another possible option, the external controller accesses the ready/busy status via the same communication path over which it communicates commands and data. When the control circuitry is ready, the external controller knows that it is able to send commands and data to the control circuitry via the one or more communication paths, and the control circuitry is waiting to receive such commands, address and data. When the control circuitry is busy, the external controller waits to send most commands and data to the control circuitry. Commands for suspending and resuming tasks can be provided from the external controller to the control circuitry when the status is ready or busy, but may not be acted on by the control circuitry immediately when the status is busy depending on the stage of flash operation.

The external controller can thus communicate with the control circuitry at any time, even when the busy status is set for the communication path. In one approach, the external controller 26 provides a manual suspend command (MSuspend) to the control circuitry via the communication path and provides other commands and data to, and receives data from, the control circuitry via the communication path. Each control circuitry 18, 24 can communicate with its storage elements via a respective communication path 17, 19 internal to the memory chip. This internal communication path can have a ready or busy status (identified by the signal InternalBusyn discussed further below).

The commands provided to the control circuitry can include a manual resume command (MResume), a program command, a read command, an erase command, a command to enter a low power mode and a status check command. The data provided to the control circuitry can include program data which is to be written to storage elements. The data received from the control circuitry can include read data which was read from storage elements, and status data which includes a task status and a suspend status. The status data can be returned to the external controller from the control circuitry in response to a status check command from the external controller. The status data can be a byte of data, for instance, in which the bit positions and values have pre-assigned meanings.

The task status can indicate whether a task has been successfully completed by the control circuitry, e.g., using a pass/fail indication, as well as providing a progress of the task. The progress of a program task, for instance, could indicate whether storage elements which are to be programmed to a certain target data state (e.g., A-state, B-state, . . . ) have completed programming. The task status could indicate that the A-state storage elements have completed programming but the B-state storage elements have not completed programming. The task status can be for a previous task or a current task. The task status can indicate a type of the task, including multilevel cell (MLC) erasing (read does not have status normally) or programming, or single level cell (SLC) erasing or programming. An MLC read task uses two or more control gate/word line voltages to distinguish between three or more data states, while an SLC read task uses one control gate/word line voltage to distinguish between only two data states. An MLC program task uses two or more verify voltages to program a set of storage elements to two or more data states, while an SLC program task uses one verify voltage to program a set of storage elements to only one data state. A read operation can be made up of one or more read tasks, and a program operation can be made up of one or more program tasks. A task can involve a cache of the memory die so that data is transferred into the cache from the external controller, or out of the cache to the external controller, concurrently while the control circuitry is performing another task and the primary communication path has a ready status. A program or read with cache operation is efficient because multiple tasks are performed in parallel.

The suspend status can indicate whether a task is currently suspended by the control circuitry. This is a value which is latched within the memory chip.

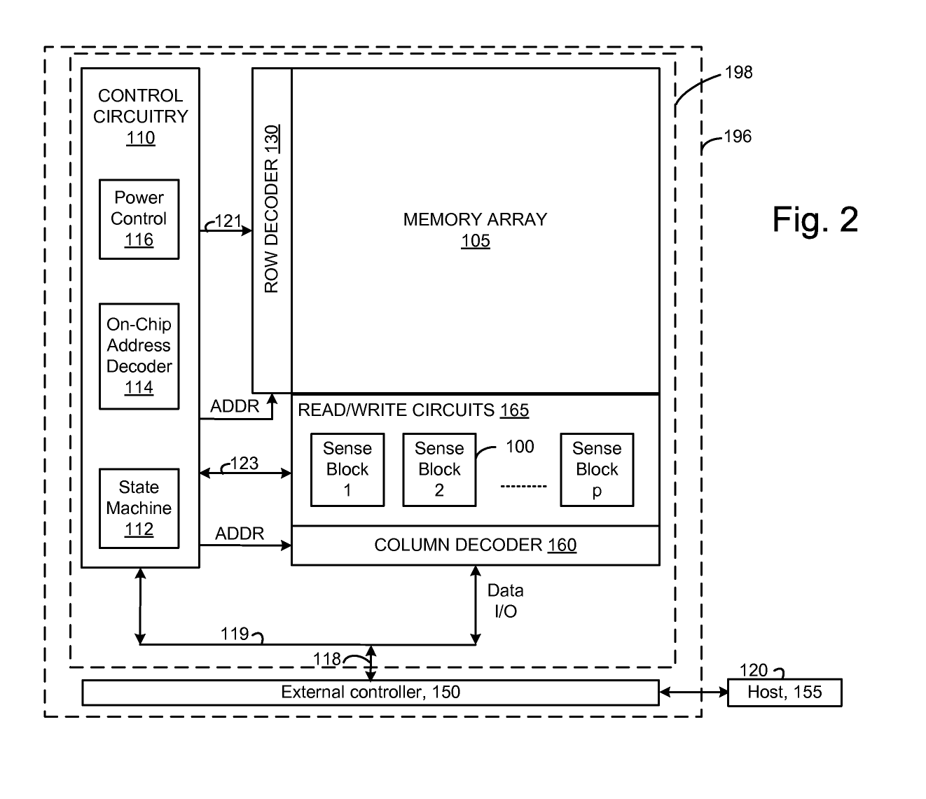

The storage system 12 is discussed next in connection with the memory device 196, and the memory die 14 and 20 are discussed next in connection with the memory die 198 (FIG. 2).

FIG. 2 provides an example of a non-volatile storage system. In particular, the example uses single row/column decoders and read/write circuits. The non-volatile memory system may include a memory device 196, such as a removable storage card, and a host 155. The memory device 196 has read/write circuits for reading and programming a page of storage elements in parallel, and may include one or more memory die 198. Memory die 198 includes a two-dimensional array of storage elements 105, control circuitry 110, and read/write circuits 165. In some embodiments, the array of storage elements can be three dimensional. For example, a device such as a secure digital (SD) memory card can have several stacked chips.

The memory array 105 is addressable by word lines via a row decoder 130 and by bit lines via a column decoder 160. The read/write circuits 165 include multiple sense blocks 100 and allow a page of storage elements to be read or programmed in parallel. Typically a external controller, also referred to as a control module, 150 is included in the same memory device 196 as the one or more memory die 198. Commands and Data are transferred between the host 155 and external controller 150 via lines 120 and between the external controller 150 and the one or more memory die 198, including the control circuitry 110, via a communication path 118 (including a bus 119).

The control circuitry 110 cooperates with the read/write circuits 165 to perform memory operations on the memory array 105. The control circuitry 110 includes a state machine 112, an on-chip address decoder 114, and a power control module 116. The state machine 112 provides chip-level control of memory operations. The on-chip address decoder 114 provides an address interface between that used by the host or a memory controller to the hardware address used by the decoders 130 and 160. The power control module 116 controls the power and voltages supplied to the word lines and bit lines during memory operations. In one approach, path 121 represents a path for voltage to be applied to word line, and path 123 represents a path in which read and program data is carried. Path 123 is analogous to path 17 or 19 in FIG. 1.

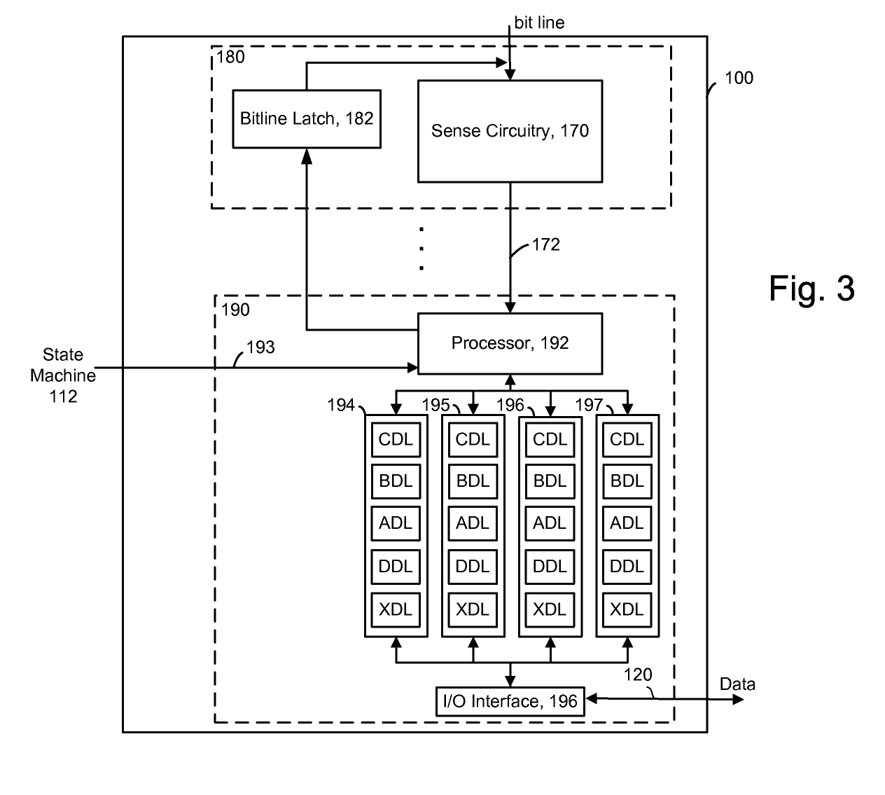

In some implementations, some of the components can be combined. In various designs, one or more of the components (alone or in combination), other than storage element array 105, can be thought of as a managing or control circuit. For example, one or more managing or control circuits may include any one of or a combination of control circuitry 110, state machine 112, decoders 114/160, power control 116, sense blocks 100 (including the processor xxx in FIG. 3), read/write circuits 165, external controller 150, etc. The sense block 100 is discussed further in connection with FIG. 3.

In another embodiment, a non-volatile memory system uses dual row/column decoders and read/write circuits. Access to the memory array 105 by the various peripheral circuits is implemented in a symmetric fashion, on opposite sides of the array, so that the densities of access lines and circuitry on each side are reduced by half. Thus, the row decoder is split into two row decoders and the column decoder into two column decoders. Similarly, the read/write circuits are split into read/write circuits connecting to bit lines from the bottom and read/write circuits connecting to bit lines from the top of the array 105. In this way, the density of the read/write modules is reduced by one half.

FIG. 3 is a block diagram depicting one embodiment of a sense block. An individual sense block 100 is partitioned into one or more core portions, referred to as sense modules 180 or sense amplifiers, and a common portion, referred to as a managing circuit 190. In one embodiment, there will be a separate sense module 180 for each bit line and one common managing circuit 190 for a set of multiple, e.g., four or eight, sense modules 180. Each of the sense modules in a group communicates with the associated managing circuit via data bus 172. Thus, there are one or more managing circuits which communicate with the sense modules of a set of storage elements.

Sense module 180 comprises sense circuitry 170 that performs sensing by determining whether a conduction current in a connected bit line is above or below a predetermined threshold level. Sense module 180 also includes a bit line latch 182 that is used to set a voltage condition on the connected bit line. For example, a predetermined state latched in bit line latch 182 will result in the connected bit line being pulled to a state designating program inhibit (e.g., 1.5-3 V). As an example, a flag=0 can inhibit programming, while flag=1 does not inhibit programming.

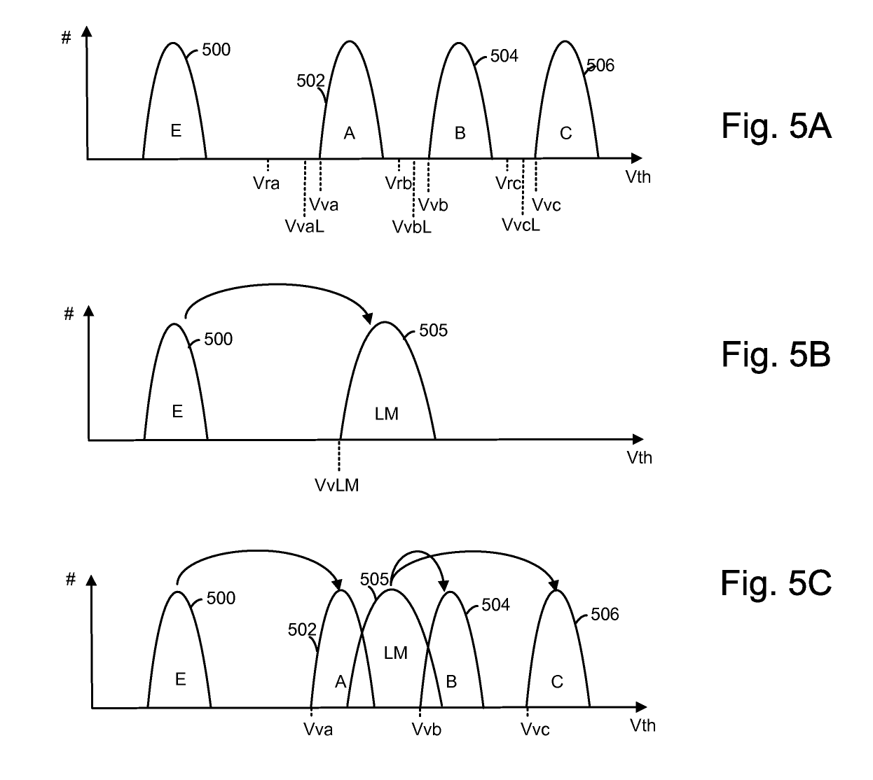

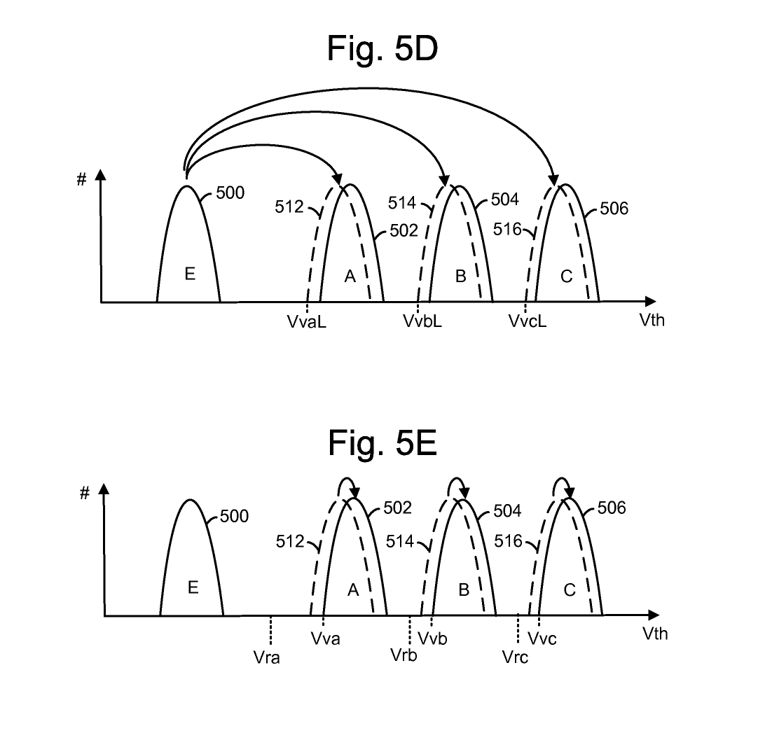

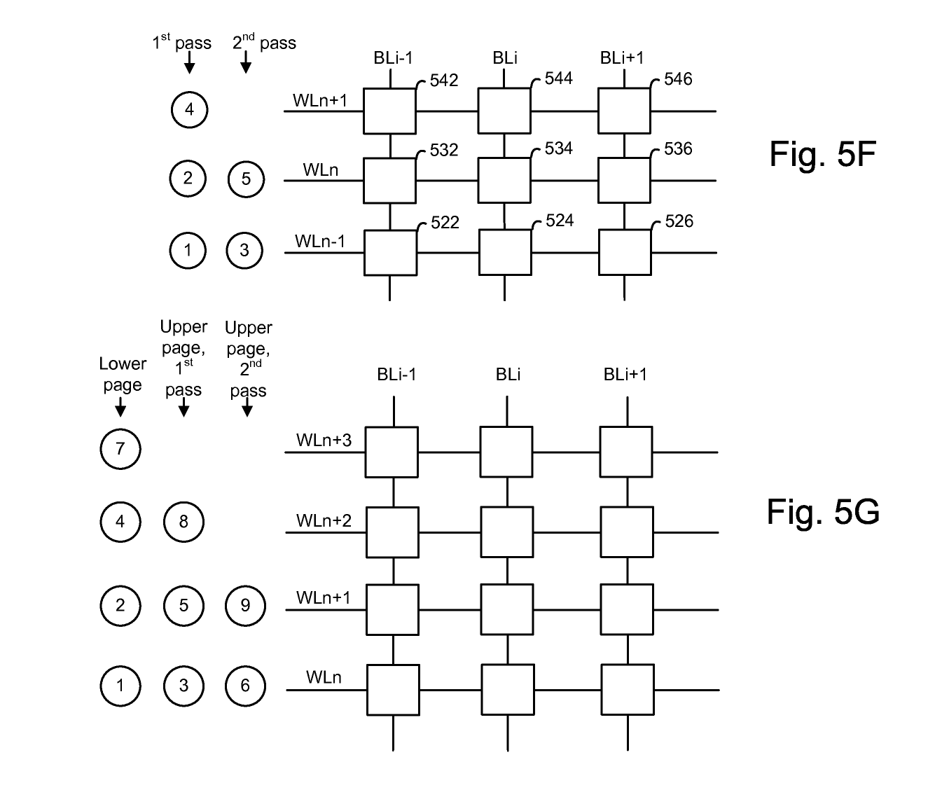

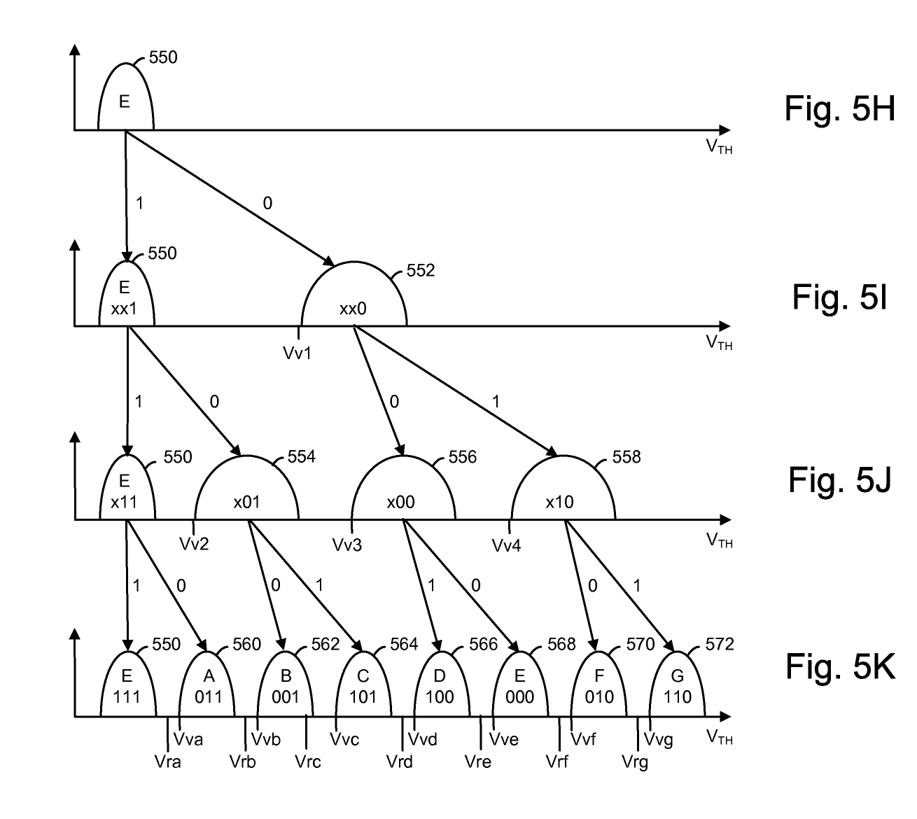

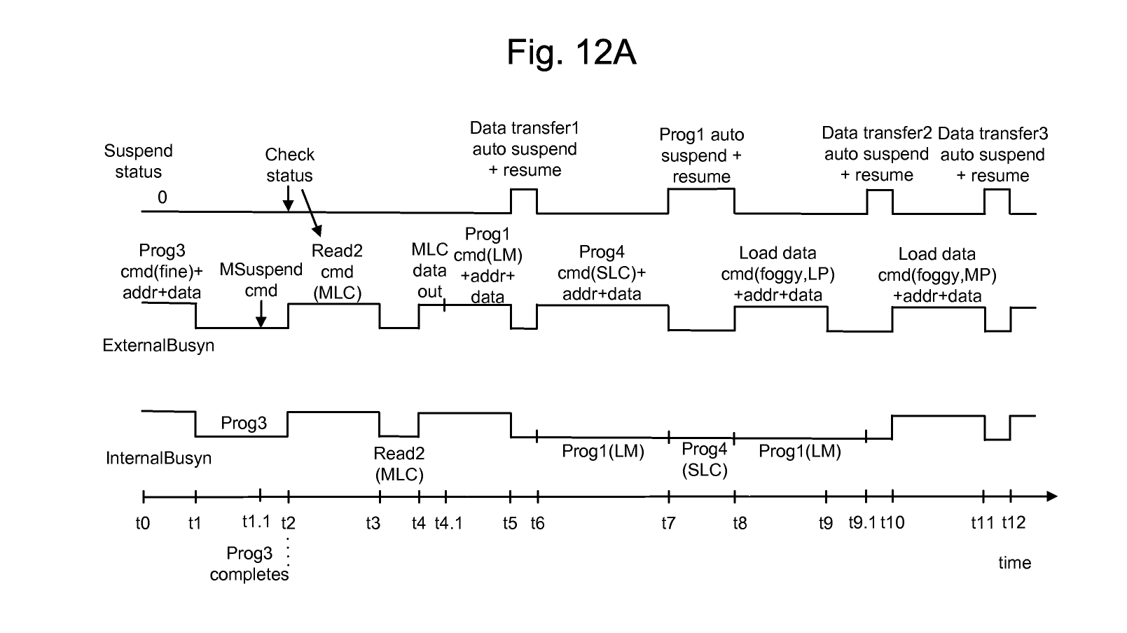

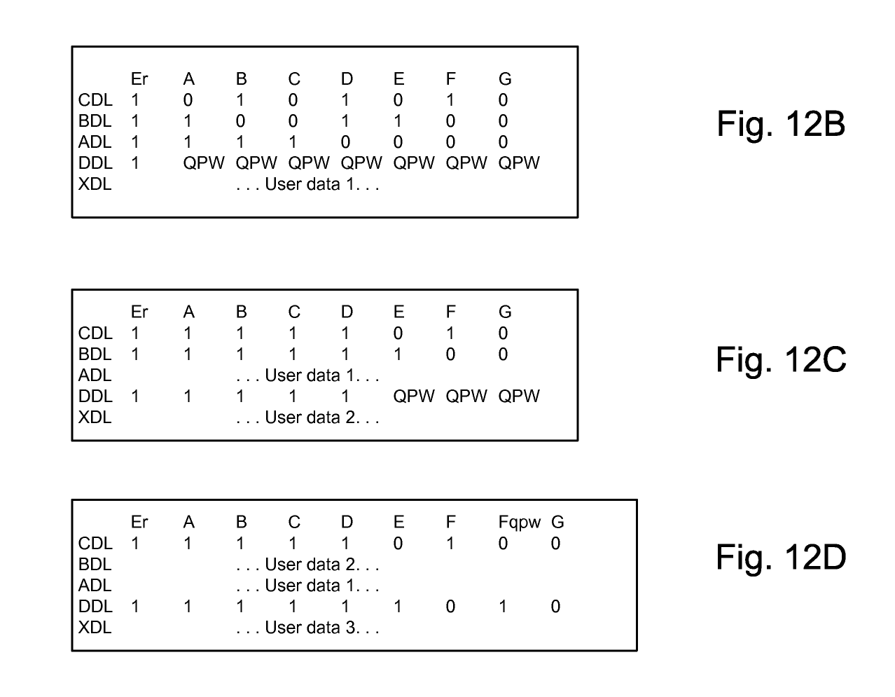

Managing circuit 190 comprises a processor 192, four example sets of data latches 194-197 and an I/O Interface 196 coupled between the set of data latches 194 and data bus 120. One set of data latches can be provide for each sense module, and data latches identified by XDL, DDL, ADL, BDL and CDL may be provided for each set. In some cases, additional data latches may be used. The use of data latches is discussed further, e.g., in connection with FIGS. 12B-12D. In one approach, in a memory device which uses eight data states, XDL stores user data, DDL stores an indication of whether quick pass write programming is used (discussed below in connection with FIG. 5A), ADL stores a lower page of data, BDL stores a middle page of data and CDL stores an upper page of data.

Processor 192 performs computations, such as to determine the data stored in the sensed storage element and store the determined data in the set of data latches. Each set of data latches 194-197 is used to store data bits determined by processor 192 during a read operation, and to store data bits imported from the data bus 120 during a programming operation which represent write data meant to be programmed into the memory. I/O interface 196 provides an interface between data latches 194-197 and the data bus 120.

During reading, the operation of the system is under the control of state machine 112 that controls the supply of different control gate voltages to the addressed storage element. As it steps through the various predefined control gate voltages corresponding to the various memory states supported by the memory, the sense module 180 may trip at one of these voltages and a corresponding output will be provided from sense module 180 to processor 192 via bus 172. At that point, processor 192 determines the resultant memory state by consideration of the tripping event(s) of the sense module and the information about the applied control gate voltage from the state machine via input lines 193. It then computes a binary encoding for the memory state and stores the resultant data bits into data latches 194-197. In another embodiment of the managing circuit 190, bit line latch 182 serves double duty, both as a latch for latching the output of the sense module 180 and also as a bit line latch as described above.

Some implementations can include multiple processors 192. In one embodiment, each processor 192 will include an output line (not depicted) such that each of the output lines is wired-OR'd together. In some embodiments, the output lines are inverted prior to being connected to the wired-OR line. This configuration enables a quick determination during the program verification process of when the programming process has completed because the state machine receiving the wired-OR can determine when all bits being programmed have reached the desired level. For example, when each bit has reached its desired level, a logic zero for that bit will be sent to the wired-OR line (or a data one is inverted). When all bits output a data 0 (or a data one inverted), then the state machine knows to terminate the programming process. Because each processor communicates with eight sense modules, the state machine needs to read the wired-OR line eight times, or logic is added to processor 192 to accumulate the results of the associated bit lines such that the state machine need only read the wired-OR line one time. Similarly, by choosing the logic levels correctly, the global state machine can detect when the first bit changes its state and change the algorithms accordingly.

During program or verify operations, the data to be programmed (write data) is stored in the set of data latches 194-197 from the data bus 120. The programming operation, under the control of the state machine, comprises a series of programming voltage pulses applied to the control gates of the addressed storage elements. Each program pulse is followed by a read back (verify) to determine if the storage element has been programmed to the desired memory state. In some cases, processor 192 monitors the read back memory state relative to the desired memory state. When the two are in agreement, the processor 192 sets the bit line latch 182 to cause the bit line to be pulled to a state designating program inhibit. This inhibits the storage element coupled to the bit line from further programming even if program pulses appear on its control gate. In other embodiments the processor initially loads the bit line latch 182 and the sense circuitry sets it to an inhibit value during the verify process.

Each set of data latches 194-197 may be implemented as a stack of data latches for each sense module. In one embodiment, there are three data latches per sense module 180. In some implementations, the data latches are implemented as a shift register so that the parallel data stored therein is converted to serial data for data bus 120, and vice versa. All the data latches corresponding to the read/write block of M storage elements can be linked together to form a block shift register so that a block of data can be input or output by serial transfer. In particular, the bank of read/write modules is adapted so that each of its set of data latches will shift data in to or out of the data bus in sequence as if they are part of a shift register for the entire read/write block.

The data latches identify when an associated storage element has reached certain mileposts in a programming operations. For example, latches may identify that a storage element's Vth is below a particular verify level. The data latches indicate whether a storage element currently stores one or more bits from a page of data. For example, the ADL latch is flipped (e.g., from 0 to 1) when a lower page bit is stored in an associated storage element. The BDL latch is flipped when a middle page bit is stored in an associated storage element. The CDL latch is flipped when an upper page bit is stored in an associated storage element. A bit is stored in a storage element when the Vth exceeds an associated verify level.

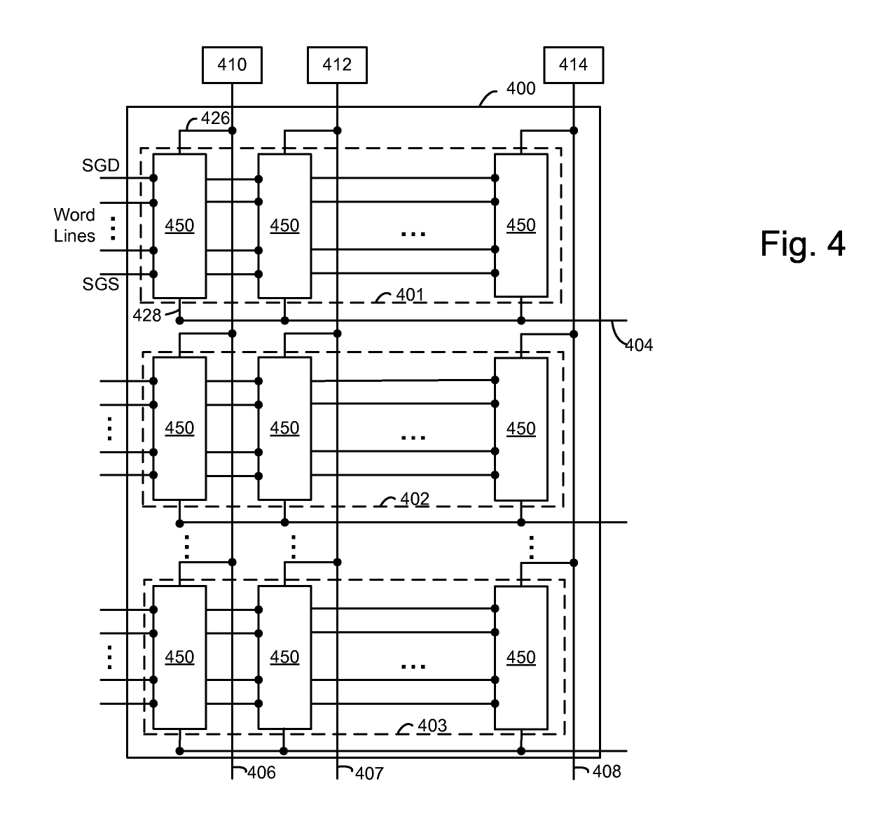

FIG. 4 is a block diagram of an array 400 of NAND flash memory cells which can be used in the memory array 105 of FIG. 2. Along each column, a bit line 406, 407 and 408, is coupled to the drain terminal 426 of the drain select gate for the NAND string 450. Along each row of NAND strings, a source line 404 may connect all the source terminals 428 of the source select gates of the NAND strings.

The array of storage elements is divided into a large number of blocks 401, 402, . . . , 403 of storage elements. As is common for flash EEPROM systems, the block is the unit of erase. That is, each block contains the minimum number of storage elements that are erased together. Each block is typically divided into a number of pages. A page is the smallest unit of programming. One or more pages of data are typically stored in one row of storage elements. For example, a row typically contains several interleaved pages or it may constitute one page. All storage elements of a page will be read or programmed together. Moreover, a page can store user data from one or more sectors. A sector is a logical concept used by the host as a convenient unit of user data; it typically does not contain overhead data, which is confined to the controller. Overhead data may include an Error Correction Code (ECC) that has been calculated from the user data of the sector. A portion of the controller (described below) calculates the ECC when data is being programmed into the array, and also checks it when data is being read from the array. Alternatively, the ECCs and/or other overhead data are stored in different pages, or even different blocks, than the user data to which they pertain.

A sector of user data is typically 512 bytes, corresponding to the size of a sector in magnetic disk drives. Overhead data is typically an additional 16-20 bytes. A large number of pages form a block, anywhere from 8 pages, for example, up to 32, 64 or more pages. In some embodiments, a row of NAND strings comprises a block.

Additionally, sense circuits such as sense amplifiers can be connected to each bit line, or shared among bit lines. Examples include sense circuits 410, 412, . . . , 414, are each equivalent to the sense amplifier 180 in FIG. 3, in one implementation.

FIGS. 5A-5K discuss example programming operations which may be performed in a non-volatile storage system.

FIG. 5A depicts an example set of threshold voltage distributions for a four-state memory device in which each storage element stores two bits of data. A first threshold voltage (Vth) distribution 500 is provided for erased (E-state) storage elements. Three Vth distributions 502, 504 and 506 represent programmed states A, B and C, respectively. In one embodiment, the threshold voltages in the E-state and the threshold voltages in the A, B and C distributions are positive.

Three read reference voltages, Vra, Vrb and Vrc, are also provided for reading data from storage elements. By testing whether the threshold voltage of a given storage element is above or below Vra, Vrb and Vrc, the system can determine the state, e.g., programming condition, the storage element is in.

Further, three verify reference voltages, Vva, Vvb and Vvc, are provided. When programming storage elements to the A-state, B-state or C-state, the system will test whether those storage elements have a threshold voltage greater than or equal to Vva, Vvb or Vvc, respectively.

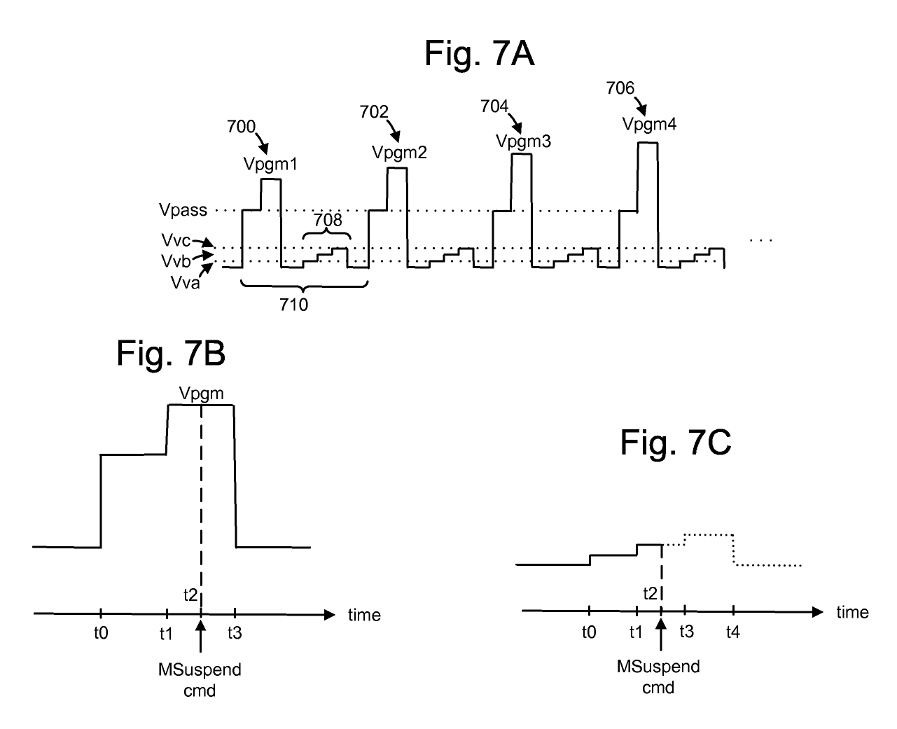

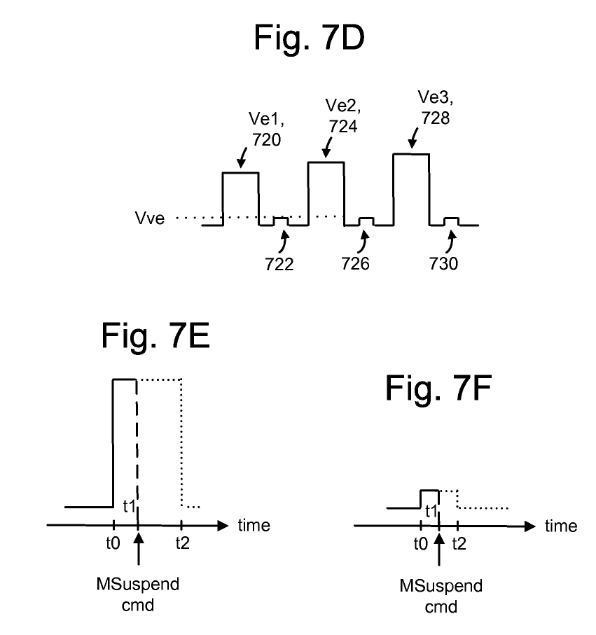

In one embodiment, known as full sequence programming, storage elements can be programmed from the E-state directly to any of the programmed states A, B or C. For example, a population of storage elements to be programmed may first be erased so that all storage elements in the population are in the E-state. A series of program pulses such as depicted in FIG. 7A will then be used to program storage elements directly into states A, B or C. While some storage elements are being programmed from the E-state to the A-state, other storage elements are being programmed from the E-state to the B-state and/or from the E-state to the C-state.

Another option is to use low and high verify levels for one or more data states. For example, VvaL and Vva are lower and higher verify levels, respectively, for the A-state, VvbL and Vvb are lower and higher verify levels, respectively, for the B-state, and VvcL and Vvc are lower and higher verify levels, respectively, for the C-state. In some case, VvcL is not used since reduced programming precision may be acceptable for the highest state. During programming, when the Vth of a storage element which is being programmed to the A-state as a target state exceeds VvaL, the programming speed of the storage element is slowed down, in a slow programming mode, such as by raising the associated bit line voltage to a level, e.g., 0.6-0.8 V, which is between a nominal program or non-inhibit level, e.g., 0 V and a full inhibit level, e.g., 4-6 V. This provides greater accuracy by avoiding large step increases in threshold voltage. When the Vth reaches Vva, the storage element is locked out from further programming. Similarly, when the Vth of a storage element which is being programmed to the B-state as a target state exceeds VvbL, the programming speed of the storage element is slowed down, and when the Vth reaches Vvb, the storage element is locked out from further programming. Optionally, when the Vth of a storage element which is being programmed to the C-state as a target state exceeds VvcL, the programming speed of the storage element is slowed down, and when the Vth reaches VvC, the storage element is locked out from further programming. This programming technique has been referred to as a quick pass write (QPW) or dual verify technique. Note that, in one approach, dual verify levels are not used for the highest state since some overshoot is typically acceptable for that state. Instead, the dual verify levels can be used for the programmed states, above the erased state, and below the highest state.

FIG. 5B illustrates a first pass of a two-pass programming technique for two-bit, four-level storage elements. In this example, a multi-state storage element stores data for two different pages: a lower page and an upper page. Example bits represented by the states are: E-state (11), A-state (01), B-state (00) and C-state (10). For E-state, both pages store a “1.” For A-state, the lower page stores a “1” and the upper page stores a “0.” For B-state, both pages store “0.” For C-state, the lower page stores “0” and the upper page stores “1.”

In the first programming pass, the lower page is programmed for a selected word line WLn. If the lower page is to remain data 1, then the storage element state remains at state E (distribution 500). If the data is to be programmed to 0, then the threshold voltage of the storage elements on WLn are raised such that the storage element is programmed to an intermediate (LM or lower middle) state (distribution 505).

In one embodiment, after a storage element is programmed from the E-state to the LM-state, as indicated by step “1” in FIG. 5F, its neighbor storage element on an adjacent word line WLn+1 in the NAND string will then be programmed with respect to its lower page in a respective first programming pass of the adjacent word line, as indicated by step “2” in FIG. 5F.

FIG. 5C illustrates a second pass of the two-pass programming technique of FIG. 5B. The A-state storage elements are programmed from the E-state distribution 500 to the A-state distribution 502, the B-state storage elements are programmed from the LM-state distribution 505 to the B-state distribution 504, and the C-state storage elements are programmed from the LM-state distribution 505 to the C-state distribution 506. The second pass of the two-pass programming technique for WLn is indicated by step “3” in FIG. 5F. The second pass of the two-pass programming technique for WLn+1 is indicated by step “5” in FIG. 5F.

FIG. 5D illustrates a first pass of another two-pass programming technique for two-bit, four-level storage elements. In this example, referred to as foggy-fine programming, the A-state, B-state and C-state storage elements are programmed from the E-state to distributions 512, 514 and 516, respectively, using lower verify levels VvaL, VvbL and VvcL, respectively. This is the foggy programming pass. A relatively large program pulse step size may be used, for instance, to quickly program the storage elements to the respective lower verify levels.

FIG. 5E illustrates a second pass of the two-pass programming technique of FIG. 5D. The A-state, B-state and C-state storage elements are programmed from the respective lower distributions to respective final distributions 502, 504 and 506, respectively, using the nominal, higher verify levels Vva, Vvb and Vvc, respectively. This is the fine programming pass. A relatively small program pulse step size may be used, for instance, to slowly program the storage elements to the respective final verify levels while avoiding a large overshoot.

Although the programming examples depict four data states and two pages of data, the concepts taught can be applied to other implementations with more or fewer than four states and more or fewer than two pages. For example, memory devices with eight or sixteen states per storage element are currently planned or in production.

Moreover, in the example programming techniques discussed, the Vth of a storage element is raised gradually as it is programmed to a target data state. However, programming techniques can be used in which the Vth of a storage element is lowered gradually as it is programmed to a target data state. Programming techniques which measure storage element current can be used as well. The concepts herein can be adapted to the different programming techniques.

FIG. 5F depicts a back-and-forth word line order for a two-pass program operation for a set of storage elements. The components depicted may be a subset of a much larger set of storage elements, word lines and bit lines. In one possible program operation, storage elements on WLn−1, e.g., storage elements 522, 524 and 526, are programmed in a first programming pass. This step is represented by the circled “1.” Next (“2”), storage elements on WLn, e.g., storage elements 532, 534 and 536, are programmed in a first programming pass. In this example, when a word line is selected for programming, verify operations occur after each program pulse. During the verify operations on WLn, one or more verify voltages are applied to WLn and pass voltages are applied to the remaining word lines including WLn−1 and WLn+1. The pass voltages are used to turn on (make conductive) the unselected storage elements so that a sensing operation can occur for the selected word line. Next (“3”), storage elements on WLn−1 are programmed in a second programming pass. Next (“4”), storage elements on WLn+1, storage elements 542, 544 and 546, are programmed in a first programming pass. Next (“5”), the storage elements on WLn are programmed in a second programming pass to their respective target states.

FIG. 5G depicts a back-and-forth word line order for a three-pass programming operation for a set of storage elements. An initial program phase of a lower page is performed before first and second passes of an upper page. A first phase programs a lower page of data, a second phase programs an upper page of data in a first pass, and a third phase completes programming of the upper page of data in a second pass. At “1”, a first phase is performed for WLn, at “2” a first phase is performed for WLn+1, at “3” a second phase is performed for WLn, at “4” a first phase is performed for WLn+2, at “5” a second phase is performed for WLn+1, at “6” a third phase is performed for WLn, at “7” a first phase is performed for WLn+3, at “8” a second phase is performed for WLn+2, at “9” a third phase is performed for WLn+1, and so forth.

FIGS. 5H-K depict programming of lower, middle and upper pages for three-bit, eight-level storage elements. Initially, all storage elements are in the erased (E) state, represented by the distribution 550 in FIG. 5H. The lower page is programmed in FIG. 5I. If the lower page is bit=1, storage elements in distribution 550 remain in that distribution. If the lower page is bit=0, storage elements in distribution 550 are programmed to an interim distribution 552 using verify level Vv1. The middle page is programmed in FIG. 5J. If the middle page is bit=1, storage elements in distribution 550 remain in that distribution, and storage elements in distribution 552 are programmed to interim distribution 508 using verify level Vv4. If the middle page is bit=0, storage elements in distribution 550 are programmed to interim distribution 554 using verify level Vv2, and storage elements in distribution 502 are programmed to interim distribution 556 using verify level Vv3.

The upper page is programmed in FIG. 5K. If the upper page is bit=1, storage elements in distribution 550 remain in that distribution, storage elements in distribution 554 are programmed to distribution 564 (state C) using verify level Vvc, storage elements in distribution 556 are programmed to distribution 566 (state D) using verify level Vvd, and storage elements in distribution 558 are programmed to distribution 572 (state G) using verify level Vvg. If the upper page is bit=0, storage elements in distribution 550 are programmed to distribution 560 (state A) using verify level Vva, storage elements in distribution 554 are programmed to distribution 562 (state B) using verify level Vvb, storage elements in distribution 556 are programmed to distribution 568 (state E) using verify level Vve, and storage elements in distribution 558 are programmed to distribution 570 (state F) using verify level Vvf. Read voltages Vra, Vrb, Vrc, Vrd, Vre, Vrf and Vrg are also depicted.

Programming using four bits per cell (16 levels) can similarly involve lower, lower-middle, upper-middle and upper pages.

FIG. 6A depicts an overview of a process in which an external controller communicates with control circuitry on a memory die. As mentioned at the outset, it is desirable to configure the external controller and control circuitry to provide a high level of control and flexibility especially for the external controller. In particular, the role of the external controller is expected to become more important in memory devices, such that the external controller should have the ability to, at any time, suspend a currently executing task at the control circuitry and cause another task to be executed, and to resume a task which was previously suspended. Also, the external controller should have the ability to manage in-progress tasks of the control circuitry, such as by providing a record of tasks. In an example process, at step 600, the external controller issues commands, including manual suspend and resume commands, checks a task status and a ready/busy status of the control circuitry and maintains a records of in-progress tasks. At step 602, the control circuitry responds to commands from the external controller, suspends and resumes tasks, and sets a task status, including a suspend status and a ready/busy status.

A manual suspend command can include a command which is issued by the external controller, to allow the external controller to instruct the control circuitry to execute an alternative task. A manual resume command can be issued by the external controller, to allow the external controller to resume a task which it previously suspended using a manual suspend command or another command such as an illegal command. Control circuitry can automatically suspend a task when the external controller issues another task in a previous executing cache command (auto suspend with a legal command sequence), without receiving a manual suspend command or an illegal command from the control circuitry. Similarly, control circuitry can automatically resume a task when it finishes the previous task and is ready to resume a task, without receiving a manual resume command from the control circuitry. A manual suspend command typically results in a task which cannot be executed by an automatic suspend, such as a task to enter a low power mode or standby mode.

FIG. 6B depicts details of an example embodiment of the process of FIG. 6A, where the external controller suspends a task at control circuitry. Steps 611, 612, 614, 615, 617, 618, 620 and 621 can be considered to be part of step 600 in FIG. 6A, and steps 613, 616 and 619 can be considered to be part of step 602 in FIG. 6A.

At step 610, the control circuitry executes a first task, e.g., in response to a previous command from the external controller or on its own initiative. An example of a task which is performed in response to a previous command from the external controller is a program, read, erase task, low power mode task or garbage collecting task.

In one implementation, at step 611, the external controller issues a manual suspend command. The manual suspend command can be issued even while the communication channel is busy. In another implementation, at step 612, the external controller can suspend a task without issuing a manual suspend command Instead, in one approach, the external controller issues an illegal command, which can include an illegal read command, such as a read command which specifies an illegal address to store data. An illegal address can be, e.g., an address in a memory array which does not exist or which is not available to store data.

At step 613, the control circuitry responds to the manual suspend command or the illegal command by suspending the first task and storing state data which identifies the current state of the task. The state data is accessed when the task is resumed to allow the task to resume from the point at which it was suspended. For example, the state data may identify an address in the memory array in which the task was being performed, where the address identifies a word line, page and/or block, for instance. In a program operation, the state data may identify a program pass number or mode (e.g., LM, foggy, fine), a program-verify iteration or loop number, a program pulse level (Vpgm), a pass voltage (Vpass) for unselected word lines, settings of a digital-to-analog converter for providing control gate read voltages for each of the programmed data states (during a read or verify operation), an identification of a channel boosting mode being used, an indication of whether A-G is complete and/or and an identifier of a word line from which programming should be resumed.

This data can be accessed to resume programming from the appropriate point. The states of latches can also be stored. The state data may be stored by the state machine 112 (FIG. 2), for instance. The control circuitry also sets a suspend status to true, then sets a ready status for the communication channel to await a further command from the external control circuitry. In one approach, the status data is a byte which includes a suspend status bit which indicates whether the memory is in a suspend state.

At step 614, in response to sensing the ready status, the external controller issues a second command to perform a second task. The external controller can constantly monitor the communication channel to determine when it transitions from busy to ready. At step 615, the external controller updates a record to indicate that the second task has been issued (see FIG. 6C). At step 616, in response to the second command, the control circuitry performs the second task, then sets a ready status for the communication channel.

In one alternative, at step 617, in response to the ready status, the external control checks the suspend status. If the suspend status is true, the external controller issues a manual resume command to resume the first task, at step 618. In one approach, the manual resume command need not identify which task was previously suspended. Instead, the control circuitry accesses the previously-stored state data to learn which task is to be resumed and the point at which it is to be resumed, and resumes the first task, at step 619. If the suspend status is false, the external controller issues another command at step 620.

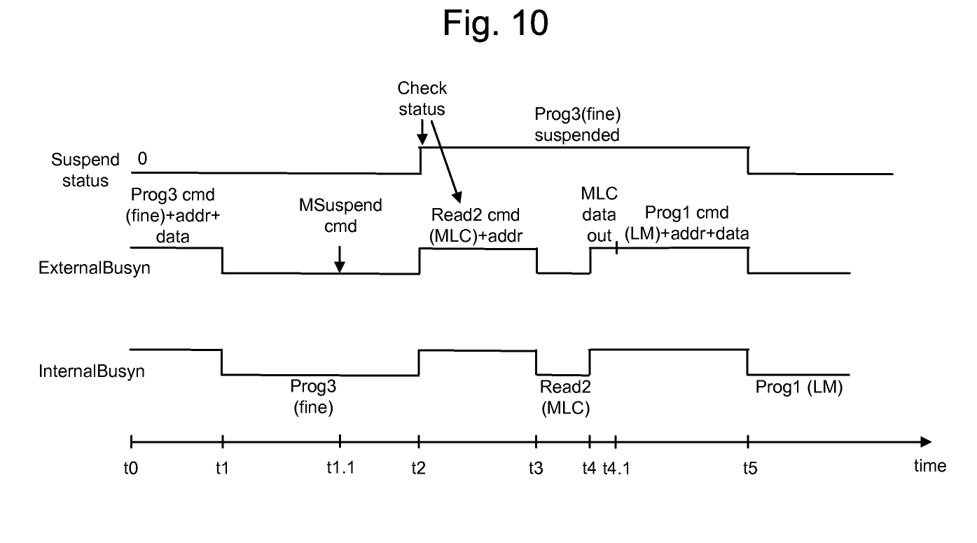

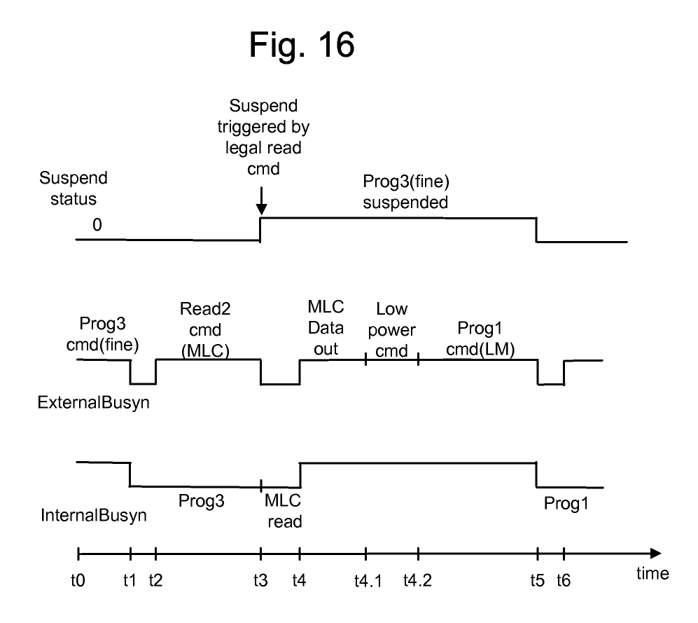

In another alternative, at step 621, the external controller issues a command which causes the first task to be aborted. For example, see FIGS. 10 and 16.

FIG. 6C depicts examples of a record which identifies in-progress tasks as discussed at step 614 of FIG. 6B. The external controller can maintain a record of one or more tasks which have been issued to the control circuitry. In one approach, a task is added to the record when the task is issued to the control circuitry and removed from the record when the external controller determines from status data that the task has been successfully completed or otherwise terminated (e.g., aborted). For example, assume that initially only task1 has been issued, as depicted by the record 630. Subsequently, task1 is suspended and task2 is issued, as depicted by the record 631. Subsequently, task2 is suspended and task3 is issued, as depicted by the record 632. Subsequently, task3 is completed and task2 is resumed, as depicted by the record 631. Subsequently, task2 is completed and task1 is resumed, as depicted by the record 630. The external controller can track multiple levels of suspended tasks, as well as multiple tasks that are performed in parallel. Regarding parallel tasks, the record 631, for instance, may reflect that task1 and task2 were issued in parallel. The record could include data associated with a task which indicates whether a suspend command has been issued for the task.

The external controller can maintain a separate record of in-progress tasks for each of multiple memory chips. An in-progress task can include a task which has been issued by the external controller but not yet completed.

To better understand how a task is suspended, example tasks of program, read and erase are explained next.

FIG. 7A depicts a series of program-verify iterations which are performed for a selected word line during a programming operation. A programming operation may include multiple program-verify iterations, such as example program-verify iteration 710, where each iteration involves applying a program pulse followed by a set 708 of one or more verify voltages, to a selected word line. In one possible approach, the program pulses are stepped up in successive iterations. Moreover, each program pulse may include a first portion which has a pass voltage (Vpass) level, e.g., 6-8 V, followed by a second, highest amplitude portion at a program level, e.g., 12-25 V. For example, a first, second, third and fourth program pulses 700, 702, 704 and 706 have program levels of Vpgm1, Vpgm2, Vpgm3 and Vpgm4, respectively, and so forth. A set 708 of one or more verify voltages, such as example verify voltages Vva, Vvb and Vvc, may be provided after each program pulse. In some cases, one or more initial program pulses are not followed by verify pulses because it is not expected that any storage elements have reached the lowest program state (e.g., A-state). Subsequently, program-verify iterations may use verify pulses for the A-state, followed by program-verify iterations which use verify pulses for the A- and B-states, followed by program-verify iterations which use verify pulses for the B- and C-states, for instance.

FIG. 7B depicts one of the program pulses of FIG. 7A showing a manual suspend command (MSuspend). As an example, the MSuspend command is received by the control circuitry at a time t2 partway through a program pulse. At this time, a portion of the program pulse of Vpgm has already been applied to the selected storage elements. In one possible implementation, the control circuitry allows the program pulse to continue to t3 so that the pulse is completed and not terminated partway through the pulse. This is advantageous since the effect of a partial program pulse is unpredictable and the program task may not resume later in a predictable manner pulse if the termination is partway through the pulse. Moreover, a program pulse typically has a relatively short duration, so waiting for the pulse to complete before suspending the program operation will result in only a relatively small delay. Thus, in one approach, the control circuitry implements MSuspend at t3 and concurrently sets the suspend state to true.

For a simple implementation, the suspend point can be after the program pulse, e.g., at t3 even when the Msuspend command is issued sooner, such as at t2. The programming operation can resume at the start of the verify pulses of the program-verify iteration, in one approach. In the next program-verify iteration, the normal program pulse and verify pulses are applied.

FIG. 7C depicts one of the sets 708 of verify pulses of FIG. 7A showing a manual suspend command. As an example, the MSuspend command is received by the control circuitry at a time t2 in the middle of a verify pulse (of a program-verify iteration). In one possible implementation, the control circuitry does not allow the set of verify pulses to continue to t4 so that the set of verify pulses is terminated partway through the pulse. Moreover, the control circuitry can implement MSuspend partway through one of verify pulses, as depicted, so that the verify pulse which starts at t1 is terminated at t2 and does not continue to t3. The dotted line indicates a remainder of a normal set of verify pulses. This approach is advantageous since it avoids a delay in implementing MSuspend, and since the termination of a verify pulse does not result in the program task being unpredictable when it resumes.

Alternatively, even if the suspend command occurs at t2, the verify operation will not stop until it is completed, at t4. When the programming is resumed, the resuming point can start at t0 to re-do the verify portion of the program-verify iteration. That is, the programming operation can resume at the start of the verify pulses of the program-verify iteration, in one approach. In the next program-verify iteration, the normal program pulse and verify pulses are applied. The Voltage level of the program pulse will be continuing step up of the pre-suspend level.

Note that FIG. 7C can apply equally to a read operation where the waveform 708 identifies a set of read pulses, e.g., Vra, Vrb and Vrc. The MSuspend command may be received by the control circuitry in the middle of a set of read pulses. In one possible implementation, the control circuitry does not allow the set of read pulses to continue to t4 so that the set of read pulses is terminated partway through the pulse. Moreover, the control circuitry can implement MSuspend partway through one of the read pulses, as depicted, so that the read pulse which starts at t1 is terminated at t2 and does not continue to t3. The dotted line indicates a remainder of a normal set of read pulses. This approach is advantageous since it avoids a delay in implementing MSuspend, and since the termination of a read pulse does not result in the read task being unpredictable when it resumes.

Alternatively, the read operation will not stop until it is completed, at t4.

FIG. 7D depicts a voltage waveform used in an erase operation. An erase operation may involve applying a series of erase pulses to the p-well of a memory device. In this example, the erase pulses increase incrementally by a step size. The erase pulse can step up at a fixed or varying rate, for instance. It is also possible to use fixed-amplitude pulses. Each erase pulse can be followed by a verify pulse with an amplitude of Vve, the verify level. Here, a sequence includes example erase pulses 720, 724 and 728, with amplitudes Ve1, Ve2 and Ve3, respectively, and erase-verify pulses 722, 726 and 730. An erase-verify iteration includes an erase pulse and a verify pulse.

FIG. 7E depicts one of the erase pulses of FIG. 7D showing a manual suspend command. As an example, the MSuspend command is received by the control circuitry at a time t1 in the middle of an erase pulse. In one possible implementation, the control circuitry does not allow the erase pulse to continue to t2 so that the erase pulse is terminated partway through the pulse. Thus, the erase pulse which starts at t0 is terminated at t1 and does not continue to t2. The dotted line indicates a remainder of a normal erase pulse. This approach is advantageous since it avoids a delay in implementing MSuspend, and since the termination of an erase pulse does not result in the erase task being unpredictable when it resumes. Also, an erase pulse is relatively long, so a relatively long delay is avoided by an early termination. When the erase operation is resumed, a normal erase-verify iteration can be applied, or the suspended erase-verify iteration can be completed by applying a normal verify pulse, or by applying a remainder of the erase pulse followed by a normal verify pulse. The voltage level applied on the erase will be continuing of the voltage step up of unfinished erase pulse before suspend.

FIG. 7F depicts one of the erase verify pulses of FIG. 7D showing a manual suspend command. As an example, the MSuspend command is received by the control circuitry at a time t1 in the middle of an erase verify pulse. In one possible implementation, the control circuitry does not allow the erase verify pulse to continue to t2 so that the erase verify pulse is terminated partway through the pulse at t1. The dotted line indicates a remainder of a normal erase verify pulse. This approach is advantageous since it avoids a delay in implementing MSuspend, and since the termination of an erase verify pulse does not result in the erase task being unpredictable when it resumes.

When the erase operation is resumed, a normal erase-verify iteration can be applied, or the suspended erase-verify iteration can be completed by applying a normal verify pulse.

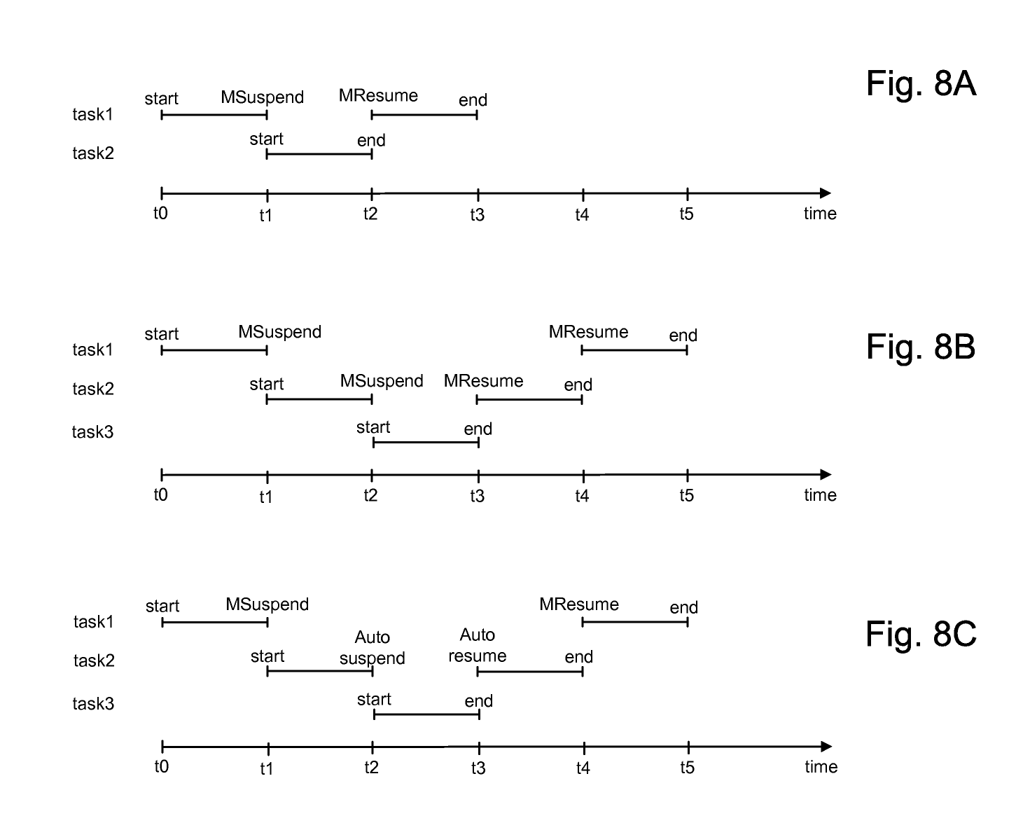

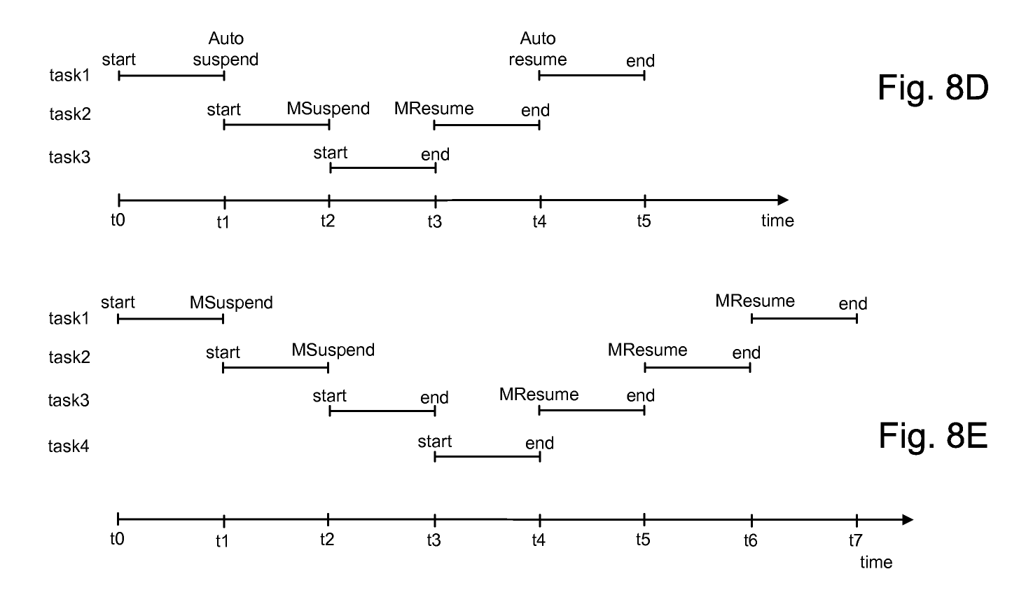

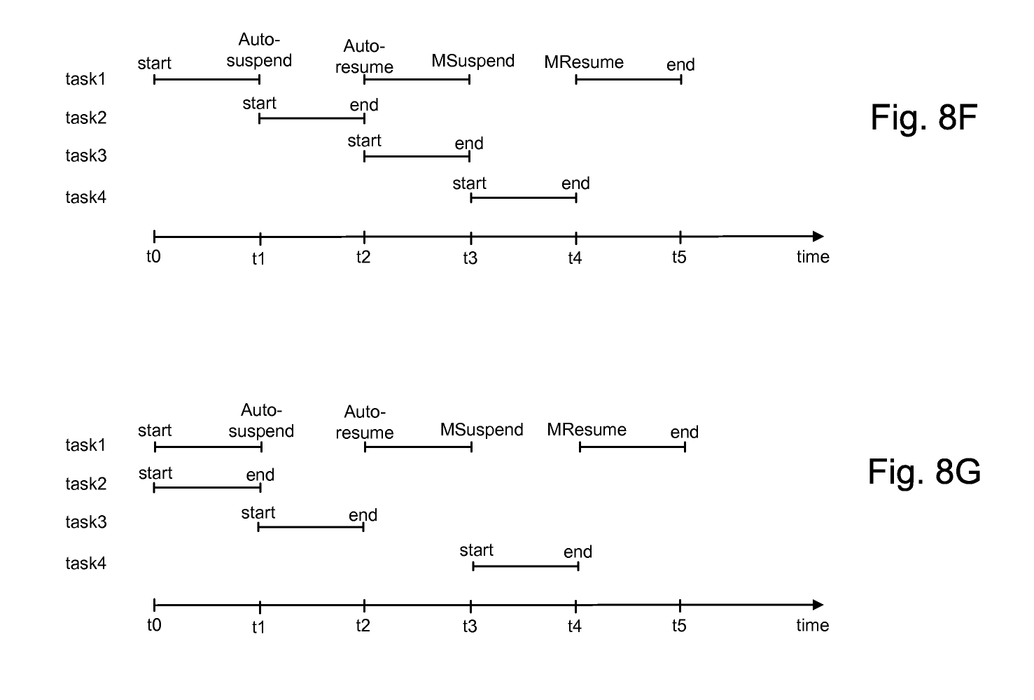

FIGS. 8A-8G provide example sequences at a conceptual level which include suspending and resuming of tasks. Task1-task4 represent any type of task.

FIG. 8A depicts an example task sequence based on the process of FIG. 6A, where a first task is manually suspended to allow a second task to execute, after which the first task is manually resumed. In this sequence, task1 starts at t0. MSuspend is issued at t1 at which time task2 starts. Task2 ends at t2, at which time MResume is issued and task1 resumes. Task1 ends at t3. This is an example of one suspended task, e.g., task1, pending while another task, e.g., task2 executes.

FIG. 8B depicts an example task sequence based on the process of FIG. 6A, where a first task is manually suspended to allow a second task to execute, after which the second task is manually suspended to allow a third task to execute, after which the second task is manually resumed, after which the first task is manually resumed. Task1 starts at t0 and MSuspend is issued at t1, at which time task2 starts. Task2 is manually suspended at t2, at which time task3 starts. Task3 ends at t3, at which time MResume is issued and task2 resumes. Task2 ends at t4, at which time MResume is issued and task1 resumes. Task1 ends at t3. This is an example of two suspended tasks pending (task1 and task2) while another task (task3) executes.

FIG. 8C depicts an example task sequence based on the process of FIG. 6A, where a first task is manually suspended to allow a second task to execute, after which the second task is automatically suspended to allow a third task to execute, after which the second task is automatically resumed, after which the first task is manually resumed. Task1 starts at t0 and MSuspend is issued at t1, at which time task2 starts. Task2 is automatically suspended at t2, at which time task3 starts. Task3 ends at t3, at which time task2 is automatically resumed. Task2 ends at t4, at which time MResume is issued and task1 resumes. Task1 ends at t3. This is an example of two suspended tasks pending (task1 and task2) while another task (task3) executes. This is also an example of an automatic suspend and resume occurring within a manual suspend and resume.

FIG. 8D depicts an example task sequence based on the process of FIG. 6A, where a first task is automatically suspended to allow a second task to execute, after which the second task is manually suspended to allow a third task to execute, after which the second task is manually resumed, after which the first task is automatically resumed. Task1 starts at t0 and is automatically suspended at t1, at which time task2 starts. Task2 is manually suspended at t2, at which time task3 starts. Task3 ends at t3, at which time task2 is manually resumed. Task2 ends at t4, at which time task1 automatically resumes. Task1 ends at t3. This is an example of two suspended tasks pending (task1 and task2) while another task (task3) executes. This is also an example of a manual suspend and resume occurring within an automatic suspend and resume.

The manual suspend is similar to the automatic suspend in that both suspend the current task, but their resume is more significantly different. For manual suspend, the external controller has total control over when to resume the task. The external controller can also issue multiple tasks without a resume. In the automatic suspend case, the resume will automatically happen after finishing one task without external controller interference. If the external controller wants to execute multiple tasks in the same level, it has to issue multiple commands to execute the tasks. The resume will happen when each task finishes in the automatic resume case. The resume will not happen when each task finishes in the manual resume case.

FIG. 8E depicts an example task sequence based on the process of FIG. 6A, where a first task is manually suspended to allow a second task to execute, after which the second task is manually suspended to allow a third task to execute, after which a fourth task executes, after which the third task is manually resumed, after which the second task is manually resumed, after which the first task is manually resumed. Task1 starts at t0 and MSuspend is issued at t1, at which time task2 starts. Task2 is manually suspended at t2, at which time task3 starts. Task3 ends at t3, at which time task4 starts. Task4 ends at t4, at which time MResume is issued and task3 resumes. Task3 ends at t5, at which time MResume is issued and task2 resumes. Task2 ends at t6, at which time MResume is issued and task1 resumes. Task1 ends at t7. This is an example of multiple tasks (task3 and task 4) being issued serially while one or more other tasks are pending (task1 and task2).

FIG. 8F depicts an example task sequence based on the process of FIG. 6A, where a first task is automatically suspended to allow a second task to execute, after which the first task is automatically resumed and concurrently a third task executes. This third task has to be specially executable in parallel with the first task—such as data in/out in parallel with program, or read in parallel with program in different plane operations in some special architecture. A fourth task then executes, after which the first task is manually resumed. Task1 starts at t0 and is automatically suspended at t1, at which time task2 starts. Task2 ends at t2 at which time task1 is automatically resumed and, concurrently, task3 starts. Task3 ends at t3, at which time task1 is manually suspended, and task4 starts. Task4 ends at t4, at which time task1 manually resumes. This is an example of concurrent tasks (task1 and task3), where one of the tasks (task1) is manually suspended.

As an example, task2 can be a read task, task3 can be a task to shift out the read data to the external controller, and task 4 can be a task to enter a low power (reduced power consumption, or sleep) mode.

FIG. 8G depicts an example task sequence based on the process of FIG. 6A, where first and second tasks concurrently execute, after which the first task is automatically suspended to allow a third task to execute, after which the first task is automatically resumed, after which the first task is manually suspended to allow a fourth task to execute, after which the first task is manually resumed. Task1 and task2 start concurrently at to. At t1, task1 is automatically suspended, task2 ends and task3 starts. Task3 ends at t2 at which time task1 is automatically resumed. Task3 is manually suspended at t3, at which time task4 starts. Task4 ends at t4, at which time task1 manually resumes. This is an example of concurrent tasks (task1 and task2), where one of the tasks (task1) is subsequently automatically suspended.

As an example, task2 can be a task to load in program data from the external controller, task3 can be a task to program the loaded data to the storage elements, and task 4 can be a task to enter a low power mode, e.g., a reduced power consumption or sleep mode.

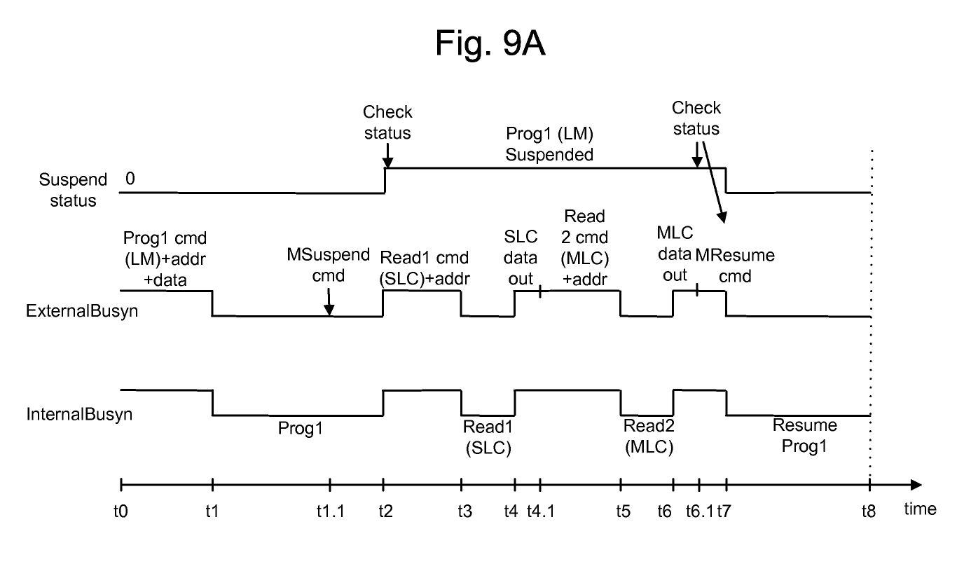

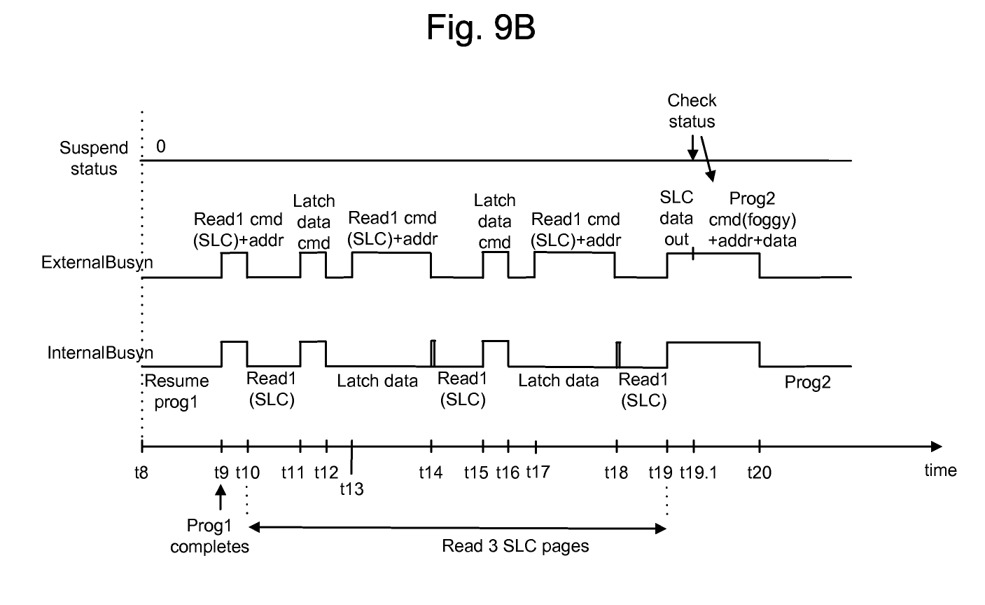

FIGS. 9A-12A and 13-17 provide example sequences at a signal level which include suspending and resuming of tasks.

Some general guidelines may be provided as follows. The storage elements may be arranged in multiple blocks, where the multiple blocks share a set of bit lines and a set of sense amplifiers (as indicated in FIG. 4), and each sense amplifier has a respective set of a number N>1 of data latches (as indicated in FIG. 3). Before the external controller provides a command to the control circuitry, the external controller may confirm that a number of data latches which might be used by all tasks together, per sense amplifier, does not exceed N. Thus, the external controller can keep track of the number of data latches per sense amplifier which are in use and the number which are free. In one approach, during a program suspend time, SLC program, SLC read or MLC page-by-page read are allowed if only one data latch per sense amplifier is available. Additional operations may be allowed if additional data latches are available.

Further, an MLC program command (cmd) can be issued to abort a suspend signal and reset all MLC NAND internal parameters to default values.

One constraint which may be imposed is that, during a suspend state, power cannot be cut off. Instead, a low power mode current (Ice) can be used to maintain the data in the latches. Further, in the case of power loss during suspend, the system side (external controller) can manage the case.

Moreover, a manual suspend/resume can be performed using a prefix command, which does not include an address. An advantage is that this is a relatively short command which can be quickly sent and received.

Along the time lines, the time increments are not necessarily evenly spaced or to scale. Also, the time increments or markings are not necessarily comparable in the different figures.

In FIGS. 9A-12A and 13-17, “read1 cmd” represents a command for a first type of reading such as SLC reading, and “read2 cmd” represents a command for a second type of reading such as MLC reading. Each of these commands typically includes an address to read data from in a memory array. Moreover, “prog1 cmd” represents a command for a first type of programming such as LM phase programming, “prog2 cmd” represents a command for a second type of programming such as foggy phase programming, “prog3 cmd” represents a command for a third type of programming such as fine phase programming, and “prog4 cmd” represents a command for a fourth type of programming such as SLC programming. Each of these commands typically includes an address to program data to in a memory array as well as data to be programmed. These commands can be issued one or more times.

FIG. 9A depicts an example scenario based on the process of FIG. 6A, where the external controller provides a manual suspend command and a manual resume command to control circuitry. In one possible implementation, multiple read operations are allowed after a suspend. Also, after an MLC program task is suspended, multiple operations for SLC read, or MLC page-by-page read can be inserted during the suspend state. We can assume there is no SLC program in a suspend state. A status bit can be provided to the external controller when it issues a status command to the control circuitry. The suspend status bit is 1 (suspend=true) or 0 (suspend=false) during the MLC program suspend mode, for instance. The external controller can check the suspend status bit after issuing the manual suspend command, MSuspend, and before issuing the manual resume command, MResume. Further, the manual suspend/resume mode can use a cache operation or a non-cache operation. A cache operation can involve MLC programming at the same time read data is output, while a non-cache operation can involve MLC programming without outputting read data at the same time. MSuspend should be accepted by the control circuitry via the communication path when the communication path has the busy status (MLC program BUSY), and the MResume command should be accepted by the control circuitry via the communication path when the communication path has the ready status.

In this example, between t0-t1, the suspend status is 0, indicating that no task is currently suspended at the control circuitry. ExternalBusyn represents the negative of a ready/busy status of the primary communication path, so that ExternalBusyn=1 denotes ready and ExternalBusyn=0 denotes busy. InternalBusyn represents the negative of a ready/busy status of an internal communication path between the control circuitry and the storage elements, so that InternalBusyn=1 denotes ready and InternalBusyn=0 denotes busy. From t0-t1, the external controller issues prog1 cmd to the control circuitry via the primary communication path. The program command is for the LM phase of programming and is followed by an address (+addr) in the memory array at which the data should be programmed, and the program data itself (+data). From t1-t1.1, the prog1 command is executed by the control circuitry. At t1.1, the external controller decides to issue MSuspend. However, the control circuitry does not transition to the suspend state (with suspend status=1) until t2. Generally, the control circuitry transitions to the suspend state at the earliest possible time (see FIGS. 7B-7F) at which a task can be suspended and later resumed without resulting in unpredictable behavior.

When the external controller detects that ExternalBusyn goes high at t2, it can check the status data to learn that the suspend status=true (1), and update its records accordingly. In particular, the external controller learns that the previous task that it issued (prog1) was suspended. The external controller at this time is free to issue a new command, read1 cmd, and an associated address for reading data from a memory array. Once the command is issued, ExternalBusyn goes low and the control circuitry executes the read task at t3-t4 which is defined by the command. After data is read, it is output by the control circuitry to the external controller via the primary communication path at t4-t4.1. The external controller can learn that the read operation has been completed by again checking the status data, so that the external controller is free to issue a new command at t4.1. Another read command, read2 cmd, is issued at this time with an associated address. Once the command is issued, ExternalBusyn goes low and the control circuitry executes the read task at t5-t6 which is defined by the command. After data is read, it is output by the control circuitry to the external controller via the primary communication path at t6-t6.1. At t6.1, the external controller is free to issue another command.

In this case, the external controller decides to resume the prog1 task. The external controller first checks the suspend status to confirm that the control circuitry is in a suspend status, then issues MResume from t6.147. In response, at t7, the control circuitry accesses the state data and resumes prog1 at the point it was suspended. In some cases, suspend status=0 even if the external controller issued MSuspend. This may occur, e.g., if the task which was to be suspend had already completed, so that the control circuitry did not suspend it, or the external controller issued a command which aborted the suspend state. Prog1 resumes from t7-t8. An example continuation of this scenario is discussed in connection with FIG. 9B.

FIG. 9B depicts an example scenario which can follow the scenario of FIG. 9A, where a program task completes so that no manual suspend is needed to allow a read task to execute. Note that t8 here is the same as t8 in FIG. 9A. Here, grog 1 completes at t9. At t9, sensing ExternalBusy going high, the external controller is free to issue a new command, which is a read1 cmd with address from t9-t10. The address may be for a first page of data to be read. The control circuitry executes the command from t10-t11. At t11, sensing ExternalBusy going high, the external controller is free to issue a new command, which is a latch data command which identifies a set of latches (e.g., set “A”). The control circuitry executes the command as a latch task from t12-t14, by transferring the read data obtained from t10-t11 to the set of latches “A”. At t13, sensing ExternalBusy going high, the external controller is free to issue a new command, which is another read1 command with address, such as for a second page of data to be read.

The control circuitry executes the command by reading data at the specified address from t14-t15. At t15, sensing ExternalBusy going high, the external controller is free to issue a new command, which is a latch data command which identifies a set of latches (e.g., set “B”). The control circuitry executes the command as a latch task from t16-t18, by transferring the read data obtained from t14-t15 to the set of latches “B”. At t17, sensing ExternalBusy going high, the external controller is free to issue a new command, which is another read1 command with address, such as for a third page of data to be read. The control circuitry executes the command by reading data at the specified address from t18-t19. At t19, the data read at t18-t19 is output to the external controller. No transfer to a latch is performed for this read data. In total, three SLC pages of data may be read.

At t19.1, the external controller checks the suspend status to learn that it is false, so that no task is suspended. The external controller thus knows it can issue a new command without resuming a suspended task. At t19.1-t20, the external controller issues a prog2 command, along with an address to program data and the data to be programmed. After t20, the prog2 task is executed.

FIG. 10 depicts an example scenario based on the process of FIG. 6A, where the external controller issues a manual suspend command to control circuitry to suspend a first program task to allow a read task to execute, and issues a second program task which causes the first program task to be aborted. This scenario is similar to that of FIG. 9A from t0-t2 except a fine programming task is involved instead of an LM programming task.

When the external controller detects that ExternalBusyn goes high at t2, it checks the status data to learn that the suspend status=true (1), and updates its records accordingly. In particular, the external controller learns that the previous task that it issued (prog3) was suspended. The external controller at this time is free to issue a new command, read2 cmd, with an associated address for reading data from a memory array. Once the command is issued, ExternalBusyn goes low and the control circuitry executes the read task at t3-t4. After data is read, it is output by the control circuitry to the external controller via the primary communication path at t4-t4.1. The external controller can learn that the read operation has been completed by again checking the status data, so that the external controller is free to issue a new command at t4.1. The prog1 cmd is issued at this time with an associated address. Once the command is issued, ExternalBusyn goes low and the control circuitry executes the program task starting at t5.

However, the prog1 cmd also causes the suspend status to transition to false, since the suspended program command (prog3) is aborted and prog1 is executed instead. The integrity of the data which was programmed by prog3 is not known. The system side (external controller) can manage the word line which was being programmed by prog3 using a hardware error (EPWR) sequence. Prog1 can include an instruction to reset programming-related state data so that any suspended program task is aborted.

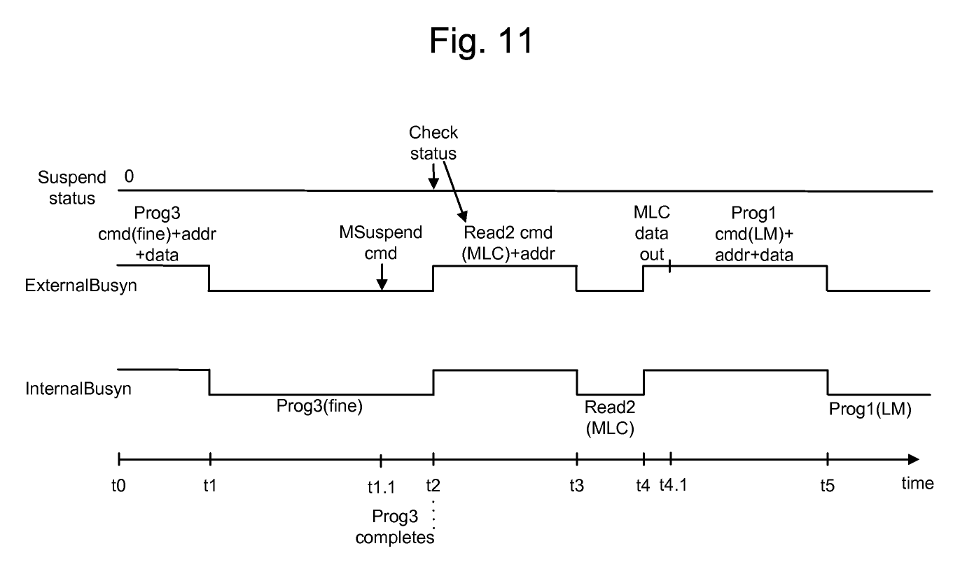

FIG. 11 depicts an example scenario based on the process of FIG. 6A, where the external controller provides a manual suspend command to control circuitry to suspend a program task, but the program task completes so that it is not suspended.

If a suspend command is received by the control circuitry when a program command has already completed, the control circuitry can ignore the suspend command and keep the suspend status at false. The external controller should check the suspend status after issuing MSuspend and before using MResume, so that it can accurately update its record of in-progress tasks. In particular, the status check command can be issued after Muspend to check if the suspend state is true or false. Also, the status check command can be issued before MResume to ensure the suspend state is true before issuing MResume. If the suspend state is false, then MResume is not needed to perform another task.

Here, MSuspend is issued at t1.1 and we assume prog3 task has completed by the time ExternalBusyn goes high. This can occur when the prog3 task is close to completion when MSuspend is issued. The control circuitry can check it status data to learn that the prog3 task has been completed. In response to ExternalBusyn going high, the external controller checks the suspend status and learns that it is false. In response, the external controller can update its record to indicate that the prog3 task has completed. The external controller also issues a read2 cmd from t2-t3, which is executed by the control circuitry at t3-t4. The read data is output from t4-t4.1. At t4.1, the external controller is free to issue another command, which is prog1, and which is executed starting at t5. Prog1 can be issued without MResume.

FIG. 12A depicts an example scenario based on the process of FIG. 6A, where the external controller provides a manual suspend command to control circuitry, and the control circuitry performs an automatic suspend and resume.

In particular, the control circuitry starts an automatic suspend and resume mode by using a cache program command (t4.1-t5). If this automatic suspend is executed, the user/external controller has to make sure that the status is checked and prog3 is terminated. In an automatic suspend and resume mode, a SLC program command (prog4) can be executed from t7-t8 after which an LM phase of MLC program (prog1) will be automatically resumed, from t8-t9. Generally, in an automatic suspend and resume mode, tasks such as SLC program and read, MLC single page read, and data transfer can be executed. A status check command is issued after each MSuspend and MResume. However, there is no need to check the suspend status in the automatic suspend mode. It can be sufficient to check the program status. Moreover, to switch from manual suspend and resume mode to automatic suspend and resume mode, the MLC program should be completed. A new program command can be issued after the status check indicates that the program status is “completed.” Further, the data transfer command in automatic suspend mode can be used to store additional data in the extra data latches when the MLC program advances to certain levels. For example, in an eight-level memory device in which states Er (erased), A, B, C, D, E, F and G are used, when the MLC programming finishes the A, B, C and D states, there will be one data latch ADL available.

The user can store one page of data in the ADL latches for future use, such as for programming the page in SLC or MLC blocks. Moreover, when the MLC programming finishes the A, B, C, D and E states, there will be another data latch BDL available. The user can store two pages of data in the ADL and BDL latches for future use, such as programming the page in SLC or MLC blocks. Recall that the data latches can be shared by different blocks, so they can store data for use in programming or reading different blocks.

In particular, MSuspend is issued at t1.1 during prog3, although prog3 completes at t2. At t2, in response to ExternalBusyn going high, the external controller checks the suspend status and learns that it is false. The external controller can also check a status to learn that prog3 has completed and update its records. The external controller is free to issue a new command from t2-t3, read2 cmd, which is executed from t3-t4 and the read data is output from t4-t4.1. The external controller is free to issue a new command from t4.1-t5, prog1 cmd, which is executed from t6-t7. From t5-t6, the control circuitry automatically sets suspend status=true to transfer in program data, such as a first page of data, to a set of latches “A”. In response to ExternalBusyn going high at t6, the external controller provides a prog4 cmd from t6-t7. From t6-t7, the control circuitry performs the prog1 task using the transferred in program data. From t7-t8, the control circuitry automatically suspends the prog1 task and performs the prog4 task. At t8, prog1 is automatically resumed, the suspend status transitions to false, and ExternalBusyn goes high. In response, from t8-t9, the control circuitry loads in a lower page (LP) page of data from the external controller to be used in a foggy programming phase. At t9.1, the control circuitry automatically suspends prog1 and transfers data from the set of latches “A” to a set of latches used for programming the storage elements. The suspend status transitions to false at t10, at which time ExternalBusyn goes high. In response, from t10-t11, the control circuitry loads in a middle page (MP) page of data from the external controller to be used in the foggy programming phase. At t11, the control circuitry automatically sets suspend status=true to transfer in program data, such as a second page of data, to a set of latches “B”.

FIG. 12B depicts a configuration of data latches after the first data transfer of FIG. 12A. In a first cache operation (data transfer1 in FIG. 12A), user data 1 is stored in the XDL data latches. In the DDL data latches, QPW is a bit which indicates a quick pass write status. The configuration occurs after XDL to ADL, BDL and CDL transfer.

FIG. 12C depicts a configuration of data latches after the second data transfer of FIG. 12A. In a second cache operation (data transfer2 in FIG. 12A), user data 1 is moved to the ADL latches and user data 2 is stored in the XDL latches. The configuration occurs after programming of the A, B, C and D states is complete.

FIG. 12D depicts a configuration of data latches after the third data transfer of FIG. 12A. In a third cache operation (data transfer3 in FIG. 12A), user data 1 remains in the ADL latches, user data 2 is moved to the BDL latches, and user data 3 is stored in the XL latches. The configuration occurs after programming of the E state is complete. An additional value Fqpw is present which indicates the quick pass write status. Fqpw CDL is flipped by the expression: CDL=˜(˜BDL & DDL) & CDL).

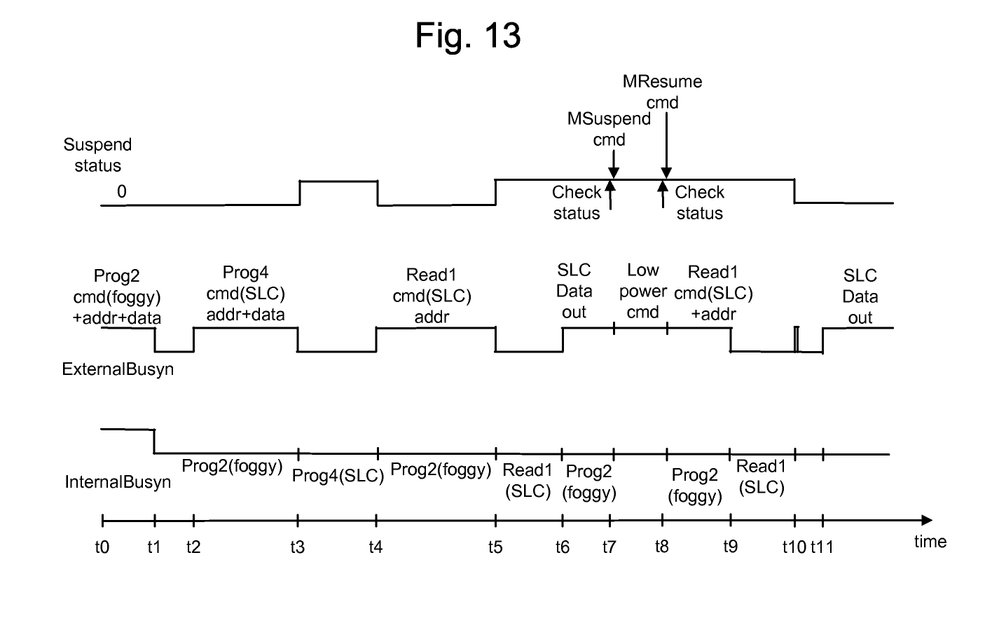

FIG. 13 depicts an example scenario based on the process of FIG. 6A, where the external controller provides a manual suspend command to control circuitry to enter a low power mode, after which the external controller provides a manual resume command A prog2 cmd is executed from t1-t3, while a prog4 cmd is issued from t2-t3. In response to the prog4 cmd, prog2 is automatically suspended from t3-t4 to allow prog4 to execute. The suspend state is set to true from t2-t3. At t4, ExternalBusyn goes high, in response to which the external controller issues a read1 cmd from t4-t5. Also, from t4-t5, prog2 is resumed. At t5, prog2 is suspended to allow the read1 cmd to execute from t5-t6. From t6-t7, the control circuitry outputs the data read from t5-t6, and resumes prog2. At t7, the external controller checks the suspend status, issues MSuspend to suspend prog2, and to issue a command to enter a low power mode, which is executed from t7-t8. At t8, the external controller checks the suspend status, and issues MResume to resume prog2, which is resumed from t8-t9, and to issue read1 cmd, which is executed from t9-t10. The suspend state is set to true from t5-t10, and returns to false at t10. The data read from t9-t10 is output to the controller after t11.

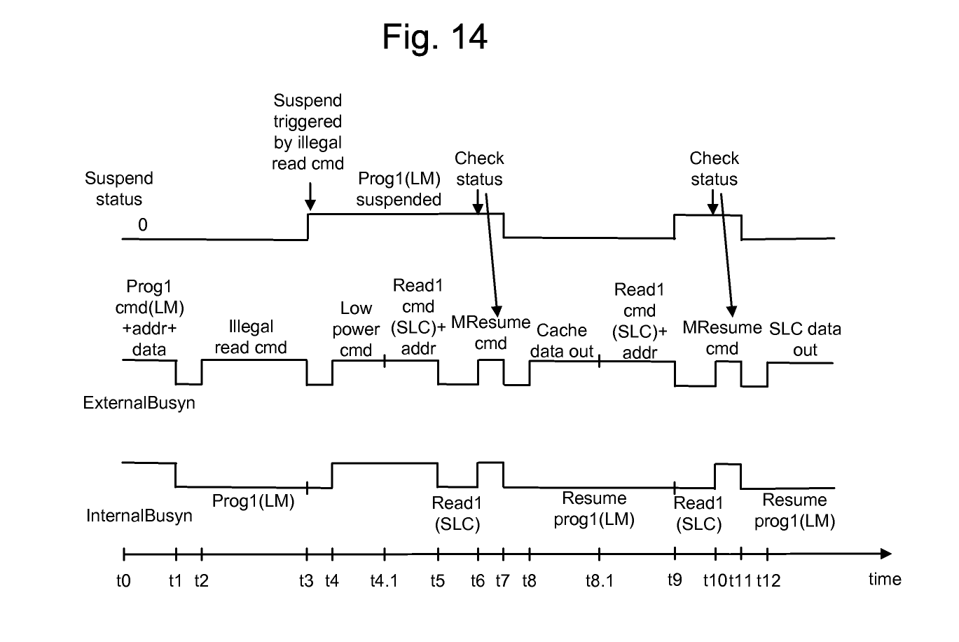

FIG. 14 depicts an example scenario based on the process of FIG. 6A, where the external controller provides an illegal read command to control circuitry to cause the control circuitry to suspend a task, after which read data is output to the external controller from a cache of the control circuitry while concurrently a program task is performed. From t2-t3, the external controller issues an illegal read command, such as a read command which uses an illegal address. In response, the suspend state is triggered at t3, when the control circuitry attempts to process the illegal command, and the current task, prog1, is suspended. The external controller issues a low power cmd from t4-t4.1, then a read1 cmd from t4.1-t5. The read1 cmd is executed from t5-t6. At t6, the external controller checks the status to learn that the suspend status is true. Thus, it knows that prog1 has been suspended, and issues MResume at t6-t7, causing prog1 to be resumed at t7. The read data from t5-t6 is output via a cache from t8-t8.1, concurrent with prog1 being executed. At t8.1 the external controller issues another read1 cmd, which is executed from t9-t10, and which causes prog1 to be suspended at t9. At t10, the external controller checks the status to learn that the suspend status is true. Thus, it knows that prog1 is suspended, and issues MResume at t10-t11, causing prog1 to be resumed again at t11. The data read from t9-t10 is output concurrently with prog1 being resumed, to gain the benefit of a cache operation. A cache operation can involve MLC programming at the same time read data is output.

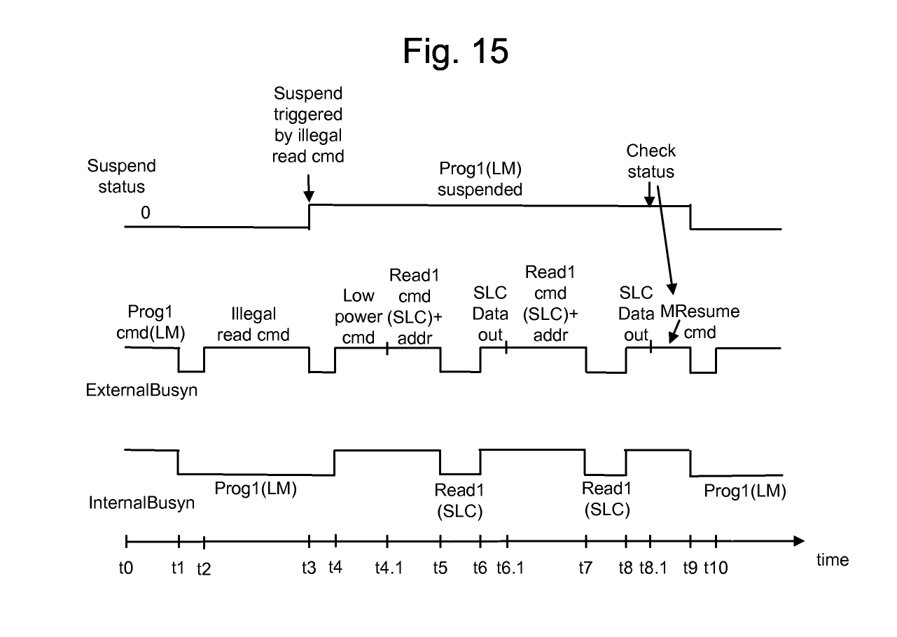

FIG. 15 depicts an example scenario based on the process of FIG. 6A, where the external controller provides an illegal read command to control circuitry to cause the control circuitry to suspend a task, after which read data is output to the external controller. This scenario is a variation of that of FIG. 14; however, there is no data output via cache. From t2-t3, the external controller issues an illegal read command. In response, the suspend state is triggered at t3, when the control circuitry attempts to process the illegal command, and the current task, prog1, is suspended. The external controller issues a low power cmd from t4-t4.1, then a read1 cmd from t4.1-t5. The read1 cmd is executed from t5-t6. The read data from t5-t6 is output from t6-t6.1. At t6.1-t7 the external controller issues another read1 cmd, which is executed from t7-t8. The read data obtained from t7-t8 is output from t8-t8.1. At t8.1, the external controller checks the status to learn that the suspend status is true. Thus, it knows that prog1 is still suspended, and issues MResume at t8.1-t9, causing prog1 to be resumed at t9.

Here, the external controller chooses to issue multiple read commands, and this is done without using MResume. The read data is output immediately after being read, and no background MLC programming is performed during the data output.

FIG. 16 depicts an example scenario based on the process of FIG. 6A, where the external controller provides a legal read command to control circuitry to cause the control circuitry to suspend a first program task, after which the external controller issues a second program task to cause the first program task to be aborted. A prog3 task is executed from t1-t3 in response to a prior command issued by the external controller. From t2-t3, the external controller issues a legal read command, such as a read command which uses a legal address. The control circuitry executes the read command from t3-t4 by suspending prog3 at t3. From t4-t4.1, the data read from t3-t4 is output to the external controller. The external controller issues a lower power command at t4.1 which is executed from t4.1-t4.2, and a prog1 cmd from t4.2-t5, which is executed starting at t5. The prog3 task is aborted at t5 when the prog1 task is processed. The low power mode can also use manual suspend and resume commands to be executed. At t4.2, a manual resume command will resume prog3 first before issuing the next prog1 command to terminate prog3 illegally.

The integrity of the data which was programmed by prog3 is not known. The system side (external controller) can manage the word line which was being programmed by prog3 using a hardware error (EPWR) sequence.

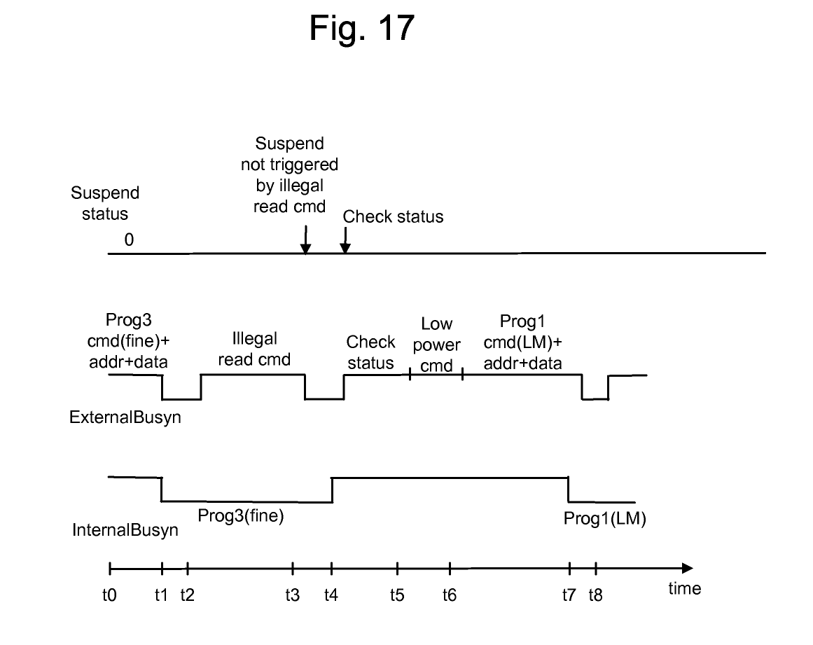

FIG. 17 depicts an example scenario based on the process of FIG. 6A, where the external controller provides an illegal read command to control circuitry to cause the control circuitry to suspend a program task, but the program task completes so that it is not suspended. Specifically, the external controller issues an illegal read command from t2-t3 while prog3 is executing, but the control circuitry keeps the suspend status at false because prog3 has completed by t3. The control circuitry thus ignores the illegal read command. The external circuitry checks the suspend status at t4 when ExternalBusyn goes high, learning that prog3 has completed and that the suspend status is false, and updating its records accordingly. The external controller can issue a low power cmd at t5 which is executed from t5-t6, and a prog1 cmd from t6-t7 which is executed after t7.

In one embodiment, a non-volatile storage system includes a memory die including control circuitry and storage elements, and an external controller, external to the memory die and in communication with the control circuitry via at least one communication path. The external controller: (a) maintains a record of multiple tasks for the control circuitry, (b) provides a suspend command to the control circuitry via the at least one communication path while the control circuitry has the busy status, a first task executes at the control circuitry when the suspend command is provided, (c) in response to detecting a ready status for the control circuitry: detects a suspend status of the control circuitry at a first time, updates the record based on the suspend status, and provides a second command to the control circuitry via the at least one communication path, and (d) subsequently, in response to again detecting the ready status for the control circuitry: detects the suspend status at a second time and if the suspend status at the second time is true, provides an additional command to the control circuitry via the at least one communication path.

In another embodiment, a method is provided for use at an external controller in communicating with control circuitry on a memory die, where the memory die includes storage elements. The method comprises: (a) maintaining a record of multiple tasks for the control circuitry, the control circuitry is in communication with the external controller via at least one a communication path, (b) providing a suspend command to the control circuitry via the at least one communication path while the control circuitry has a busy status, a first task executes at the control circuitry when the suspend command is provided, (c) in response to detecting a ready status on the at least one communication path: detecting a suspend status of the control circuitry at a first time, updating the record based on the suspend status, and providing a second command to the control circuitry via the at least one communication path, and (d) subsequently, in response to again detecting the ready status on the at least one communication path: detecting the suspend status at a second time and if the suspend status at the second time is true, providing an additional command to the control circuitry via the at least one communication path.

In another embodiment, a method is provided for use at control circuitry at a memory die, where the control circuitry is in communication with an external controller, and the memory die includes storage elements. The method comprises: (a) receiving a suspend command at the control circuitry, from the external controller, the control circuitry is in communication with the external controller via at least one a communication path, and the suspend command is received via the at least one communication path while the control circuitry has a busy status, (b) in response to the suspend command, suspending a first task which is executing, setting a suspend status to true, and providing a ready status on the at least one communication path, (c) in response to a status request from the external controller, providing the suspend status to the external controller, (c) subsequently receiving a second command at the control circuitry, from the external controller, via the at least one communication path, to perform a second task, (d) in response to the second command, starting the second task, providing a busy status on the at least one communication path and again providing the ready status on the at least one communication path, (e) in response to a further status request received from the external controller when the ready status is again provided for the at least one communication path, again providing the suspend status to the external controller, and (f) if the again-provided suspend status is true, receiving a resume command at the control circuitry, from the external controller, via the at least one communication path, to resume the first task.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A non-volatile storage system, comprising:
a memory die including control circuitry and storage elements; and
an external controller, external to the memory die and in communication with the control circuitry via at least one communication path, the external controller:
maintains a record of multiple tasks for the control circuitry,
provides a suspend command to the control circuitry via the at least one communication path while the control circuitry has the busy status, a first task executes at the control circuitry when the suspend command is provided;
in response to detecting a ready status for the control circuitry: detects a suspend status of the control circuitry at a first time, updates the record based on the suspend status, and provides a second command to the control circuitry via the at least one communication path, and
subsequently, in response to again detecting the ready status for the control circuitry: detects the suspend status at a second time and if the suspend status at the second time is true, provides an additional command to the control circuitry via the at least one communication path.

2. The non-volatile storage system of claim 1, wherein:
in response to the suspend command, the control circuitry suspends the first task, sets the suspend status to true, and provides a ready status on the at least one communication path.

3. The non-volatile storage system of claim 2, wherein:
the additional command is comprise a command to resume the first task.

4. The non-volatile storage system of claim 3, wherein:
the first task involves a phase of a multi-phase programming operation;
in connection with suspending the first task, the control circuitry stores state data which identifies the phase; and
in connection with resuming the first task, the control circuitry accesses the state data which identifies the phase.

5. The non-volatile storage system of claim 1, wherein:
in response to the additional command, the control circuitry automatically suspends and resumes at least one other task.

6. The non-volatile storage system of claim 1, wherein the external controller:
detects the suspend status at the first time via the at least one communication path by issuing a status request command to the control circuitry and receiving back data which provides the suspend status.

7. The non-volatile storage system of claim 6, wherein:
the data also indicates whether the first task has been successfully completed; and
the external controller updates the record based on the data indicating that the first task has been successfully completed.

8. The non-volatile storage system of claim 1, wherein:
if the suspend status at the second time is false, the external controller does not provide a command to the control circuitry to resume the first task.

9. The non-volatile storage system of claim 1, wherein:
the second command comprises a command to perform a second task; and
if the suspend status at the first time is true, the external controller updates the record based on the suspend status at the first time by indicating that the first task is suspended and the second task is started.

10. The non-volatile storage system of claim 1, wherein the external controller:
the second command comprises a command to perform a second task;
provides another suspend command to the control circuitry via the at least one communication path while the control circuitry has the busy status, in response to which the control circuitry suspends the second task, sets the suspend status set to true if the suspend status is not already set to true, and provides a new ready status on the at least one communication path,
in response to detecting the new ready status on the at least one communication path: detects the suspend status, updates the record based on the suspend status, and provides a third command to the control circuitry via the at least one communication path, in response to which the control circuitry provides a busy status on the at least one communication path, and
subsequently, in response to again detecting the ready status on the at least one communication path: detects the suspend status at a third time and if the suspend status at the third time is true, provides a resume command to the control circuitry via the at least one communication path to resume the second task.

11. The non-volatile storage system of claim 10, wherein the external controller:
provides a resume command to the control circuitry to resume the first task based on determining that the control circuitry has completed the second task and based on determining that the suspend status at the third time is true.

12. The non-volatile storage system of claim 1, wherein:
the suspend command is a prefix command which does not include an address.

13. The non-volatile storage system of claim 1, wherein:
the second command comprises a command to enter a low power mode.

14. The non-volatile storage system of claim 1, wherein:
the first task is one of programming, reading, erasing and entering a low power mode; and
the second command comprises a command to perform one of programming, reading, erasing and entering a low power mode.

15. The non-volatile storage system of claim 1, wherein:
the storage elements are arranged in multiple blocks, the multiple blocks share a set of bit lines and a set of sense amplifiers, each sense amplifier has a respective set of a number N of data latches;
the second command comprises a command to perform a second task; and
before the external controller provides the second command to the control circuitry, the external controller confirms that a number of data latches which might be used by the first and second tasks together, per sense amplifier, does not exceed N.

16. The non-volatile storage system of claim 1, wherein:
the first task is MLC programming; and
the second command comprises a command to perform one of SLC programming, SLC reading and MLC page-by-page reading.

17. The non-volatile storage system of claim 1, wherein:
in response to the suspend command, the control circuitry suspends the first task, which is a first program task;
the second command comprises a command to perform a task other than a program task; and
the additional command comprises a command to perform a second program task which causes the first program task to be aborted.

18. The non-volatile storage system of claim 1, wherein:
the external controller provides a third command to the control circuitry via the at least one communication path to perform a third task, in response to again detecting the ready status on the at least one communication path, after the first time and before the second time.

19. The non-volatile storage system of claim 1, wherein:
the record identifies in-progress tasks.

20. A method for use at an external controller in communicating with control circuitry on a memory die, the memory die including storage elements, the method comprising:
maintaining a record of multiple tasks for the control circuitry, the control circuitry is in communication with the external controller via at least one a communication path;
providing a suspend command to the control circuitry via the at least one communication path while the control circuitry has a busy status, a first task executes at the control circuitry when the suspend command is provided;
in response to detecting a ready status on the at least one communication path: detecting a suspend status of the control circuitry at a first time, updating the record based on the suspend status, and providing a second command to the control circuitry via the at least one communication path, and
subsequently, in response to again detecting the ready status on the at least one communication path: detecting the suspend status at a second time and if the suspend status at the second time is true, providing an additional command to the control circuitry via the at least one communication path.

21. A method for use at control circuitry at a memory die, the control circuitry is in communication with an external controller, the memory die including storage elements, the method comprising:
receiving a suspend command at the control circuitry, from the external controller, the control circuitry is in communication with the external controller via at least one a communication path, and the suspend command is received via the at least one communication path while the control circuitry has a busy status;
in response to the suspend command, suspending a first task which is executing, setting a suspend status to true, and providing a ready status on the at least one communication path;
in response to a status request from the external controller, providing the suspend status to the external controller;
subsequently receiving a second command at the control circuitry, from the external controller, via the at least one communication path, to perform a second task;
in response to the second command, starting the second task, providing a busy status on the at least one communication path and again providing the ready status on the at least one communication path;
in response to a further status request received from the external controller when the ready status is again provided for the at least one communication path, again providing the suspend status to the external controller; and
if the again-provided suspend status is true, receiving a resume command at the control circuitry, from the external controller, via the at least one communication path, to resume the first task.

22. The method of claim 21, wherein:
the first task is a program task in which multiple program-verify operations are performed, each program-verify operation involves a program operation and an associated verify operation;
the suspend command is received during one of the program-verify operations; and
the first task is suspended without completing the one of the program-verify operations.

23. The method of claim 22, wherein:
the one of the program-verify operations involves applying a program pulse to at least one selected storage element, followed by applying one or more verify pulses to the at least one selected storage element;
the suspend command is received while applying the program pulse to the at least one selected storage element; and
the first task is suspended after completing the applying the program pulse to the at least one selected storage element but before the applying one or more verify pulses to the at least one selected storage element.

24. The method of claim 22, wherein:
the one of the program-verify operations involves applying a program pulse to at least one selected storage element, followed by applying one or more verify pulses to the at least one selected storage element;
the suspend command is received while applying the one or more verify pulses to the at least one selected storage element; and
the first task is suspended before completing the applying one or more verify pulses to the at least one selected storage element.

25. The method of claim 21, wherein:
the first task is an erase task in which an erase pulse is applied to the storage elements;
the suspend command is received during the erase pulse;
the first task is suspended without completing the erase pulse.

26. A non-volatile storage system, comprising:
a memory die including control circuitry and storage elements; and
an external controller, external to the memory die and in communication with the control circuitry via at least one a communication path which has an associated ready or busy status, the external controller:
provides a read command to the control circuitry via the at least one communication path while the control circuitry has the ready status, and while the control circuitry is executing a first program task, where in response to the read command, the control circuitry sets a busy status on the at least one communication path and suspends the first program task,
in response to detecting a further ready status on the at least one communication path: provides an additional command to the control circuitry via the at least one communication path, where in response to the additional command, the control circuitry sets a busy status on the at least one communication path and then sets the ready status on the at least one communication path, and
subsequently, in response to again detecting the ready status on the at least one communication path: provides an additional command to the control circuitry via the at least one communication path.

27. The non-volatile storage system of claim 26, wherein:
the read command uses an illegal address.

28. The non-volatile storage system of claim 27, wherein:
the additional command is a read command using a legal address.

29. The non-volatile storage system of claim 26, wherein:
the additional command comprises a command to perform a second program task which causes the first program task to be aborted.

30. The non-volatile storage system of claim 26, wherein:
the additional command comprises a command to resume the first program task.

31. The non-volatile storage system of claim 30, wherein:
the external controller receives read data from a cache associated with control circuitry via the at least one communication path while the first program task is resuming

32. The non-volatile storage system of claim 26, wherein:
the control circuitry sets a suspend status to true when suspending the program task;
in response to the again detecting the ready status on the at least one communication path, the external controller detects the suspend status, where the instructing of the control circuitry via the at least one communication path to perform the at least one additional task is responsive to the suspend status being true.

33. non-volatile storage system, comprising:
a memory die including control circuitry and storage elements; and
an external controller, external to the memory die and in communication with the control circuitry via at least one a communication path, the external controller:
while the control circuitry is executing a first task and while the control circuitry has the ready status: provides a suspend command via the at least one communication path, followed by a command to enter a low power mode to the control circuitry, via the at least one communication path, the control circuitry responds to the suspend command by suspending the first task and responds to the command to enter the low power mode by entering the low power mode, and
while the control circuitry is in the low power mode and while the control circuitry has the ready status, provides a resume command to resume the first task.

34. The non-volatile storage system of claim 33, wherein:
the control circuitry provides the resume command in response to detecting that a suspend status of the control circuitry is true.

35. A non-volatile storage system, comprising:
a memory die including control circuitry and storage elements; and
an external controller, external to the memory die and in communication with the control circuitry via at least one a communication path, the external controller:
in a first time period: provides a read command to the control circuitry via the at least one communication path while the control circuitry has a ready status, and while the control circuitry is performing a first task,
in response to the read command, in a second time period which is after the first time period: the control circuitry automatically suspends the first task and performs a read task to obtain read data, after which in a third time period which is after the second time period: the control circuitry automatically resumes the first task and concurrently shifts out the read data to the external controller, and
in a fourth time period which is after the third time period: provides a suspend command to the control circuitry via the at least one communication path while the control circuitry has the busy status, to suspend the first task, and when the control circuitry has the ready status again, provides a command to the control circuitry to perform a further task.

36. The non-volatile storage system of claim 35, wherein the external controller:
in a fifth time period which is after the fourth time period, provides a command to the control circuitry via the at least one communication path to resume the first task.

37. The non-volatile storage system of claim 35, wherein:
the further task is to enter a low power mode.

38. A non-volatile storage system, comprising:
a memory die including control circuitry and storage elements; and
an external controller, external to the memory die and in communication with the control circuitry via at least one a communication path, the external controller:
in a first time period: loads in program data and provides a program command to the control circuitry via the at least one communication path while the control circuitry has a ready status, and while the control circuitry is concurrently performing a first task,
in response to the program command, in a second time period which is after the first time period: the control circuitry automatically suspends the first task and performs a program task to write the program data, after which in a third time period which is after the second time period: the control circuitry automatically resumes the first task, and
in a fourth time period which is after the third time period: provides a suspend command to the control circuitry via the at least one communication path while the control circuitry has a busy status, to suspend the first task, and when the control circuitry has the ready status again, provides a command to the control circuitry to perform a further task.

39. The non-volatile storage system of claim 38, wherein the external controller:
in a fifth time period which is after the fourth time period, provides a command to the control circuitry via the at least one communication path to resume the first task.

40. The non-volatile storage system of claim 38, wherein:
the further task is to enter a low power mode.
